(19) United States
(12) Patent Application Publication
(10) Pub. No.: US 2003/0083937 A1
(43) Pub. Date: May 1, 2003

(54) Advertisement delivery systems, advertising content and advertisement delivery apparatus, and advertisement delivery methods

(76) Inventors: Masayuki Hasegawa, Tokyo (JP); Arihiro Yoshida, Tokyo (JP)

Correspondence Address: Gerald H. Kiel, Esq., REED SMITH LLP, 375 Park Avenue, New York, NY, 10016-2391, US

(21) Appl. No.: 10/000,666

(22) Filed: Nov. 1, 2001

(51) Int. Cl. G06F 15/16

(52) U.S. Cl. 705/14; 705/10

(57) ABSTRACT

An advertisement delivery system, advertising content and advertisement delivery apparatus, and an advertisement delivery method is provided which enables a viewer to effectively utilize advertising information without difficulty and to easily reach a desired advertisement, with which an advertiser is capable of delivering its advertisement effectively to a viewer who belongs to the class of people who purchase its class of products. In an advertisement delivery system for delivering an advertisement to a viewer via a fast communication network, advertising content having one or more advertisements that are focussed on a predetermined target in advance and having an address part indicating a link relationship with a web site relating to said advertisements, and an advertisement delivery apparatus for delivering said advertising content are arranged on a fast communication network, and the advertisement delivery system delivers the advertising content to the viewer based on requests of the viewer.

### BACKGROUND OF THE INVENTION

a) Field of the Invention

The present invention relates to advertisement delivery systems, advertising content and advertisement delivery apparatus, and advertisement delivery methods utilizing fast communication networks.

b) Related Background Art

Conventionally, the general advertisement delivery model adopted for television broadcasting is for the television receiving device to receive advertising (images) sent unidirectionally by television stations, and viewers to view the advertising (images). Furthermore, as is well known, advertising (images) are broadcast in the intervals between regular program segments. Therefore, it is important for an advertiser to sponsor programs that are likely to be viewed by people who purchase its class of products, and to display its advertising (images) in the intervals between segments of the programs, in order to effectively display its advertisements to qualified (interested) viewers.

In addition, for the Internet, there are methods of delivering advertisements utilizing web sites. For example, when banner advertisements are provided on web sites, viewers of the banner advertisement can connect to the sites of the banner advertisement sponsors by clicking links to advertisements (i.e. clicking the banners) on the web sites. Furthermore, in the advertisement delivery method of such a banner advertisement system, as in advertisement delivery methods utilizing television broadcasting, it is also important for an advertiser to insert banner advertisements in web pages that are highly likely to be accessed by people who purchase its class of products, in order to encourage and persuade viewers who belong to the class of people who purchase its products to access its web site more frequently.

Since advertising (images) and audio can be simply delivered unidirectionally from a television station, for the above-mentioned advertisements delivered via television broadcast, it is important for viewers (users) to be able to select a desired advertisement from among multiple advertisements, or to obtain more detailed information relating to an advertisement that the viewer has viewed. In addition, from the transmitter side it is unclear whether or not advertising (images) or the like broadcast in the intervals between program segments are actually viewed by viewers. That is, although it is possible to perform surveys to obtain audience ratings for programs, it is unclear whether or not the viewer has viewed advertising (images) or the like broadcast in the intervals between program segments which may not have been viewed.

On the other hand, with banner advertisements on the Internet, it is possible for viewers to select desired advertisements from among multiple banner advertisements on a web site, or to obtain more detailed information after connecting to the selected advertisement page. Moreover, since the viewer browses advertisement pages by clicking on banner advertisements, it may be assumed that a viewer who clicks a banner advertisement is virtually certain to browse the corresponding advertiser's page.

In addition, since the web site via which a viewer accessed an advertiser's page is recorded in a historical log, it is easy to measure the effect of inserting a banner advertisement in a page on a particular web site. Moreover, various trading sites also exist on the Internet; and in some cases, viewers visit trading sites via banner advertisements to purchase an advertiser's products. An advertiser can determine whether the insertion of banner advertisements has resulted in visitors who purchase its products by capturing the flow of a viewer's such operations on the Internet. Therefore, it is easy to measure the effect of inserting a banner advertisement or the like that is delivered via the Internet.

However, for banner advertisements, the number of viewers is extremely small compared with the delivery of advertising (images) or the like utilizing television broadcasts. Moreover, it is hard for an advertiser to estimate or determine which web sites a viewer, who belongs to the class of people who purchase its class of products, selects and browses among the enormous number of web sites existing on the Internet—in other words, on which web sites its banner advertisements should be displayed.

In addition, it is extremely difficult for viewers to find web sites having banner advertisements linked to desired advertisement sites from among the numerous web sites on the Internet, or to retrieve and browse a desired site. Moreover, for banner advertisements, unlike advertisements delivered using television broadcasts as the medium, since banner advertisements or linked sites usually have little or no information in the form of videos, audio or the like, banner advertisements are not so attractive as an advertisement medium. Thus, such banner advertisement businesses are currently not so profitable.

In addition, although advertising information is also transmitted unilaterally as electronic mail, or added as headers or footers to electronic mail, since such advertising information is simply transmitted, it is hard to determine whether or not viewers have viewed the advertising information. Moreover, for such electronic mail formats, since large data files cannot be attached, such advertisements consist of simple character data which is not so interesting or amusing to most people.

Furthermore, in conventional advertisements, whether they utilize television broadcasts or the Internet, advertisers themselves are independent and are not physically connected or linked. Thus, while advertising information is extremely important in selecting goods or services, it is hard for viewers (users) to collect and utilize the information.

### OBJECT AND SUMMARY OF THE INVENTION

The present invention has been devised to solve the above drawbacks, and it is an objective of the present invention to provide advertisement delivery systems, advertising content and advertisement delivery apparatus, and advertisement delivery methods that enable viewers to effectively utilize advertising information without difficulty, and to easily find desired advertisements, so that advertisers are able to deliver their own advertisements effectively to viewers who belong to the group of people who purchase their class of products.

Using the advertisement system, the advertising content and advertisement delivery apparatus, and the advertisement delivery method of the present invention, a viewer can easily reach a WEB site or the like that is linked to advertising content. From the viewpoint of advertisers, the advertiser can effectively lead a viewer who belongs to the group of people purchasing their class of products to a WEB site or the like to view their advertisements. In addition, using the present invention, a viewer can receive delivery of advertising content selected according to a desired genre. Furthermore, using the present invention, since new advertising content is automatically generated based on at least one of: viewing history, delivery history, and trading history of multiple viewers, it is possible to supply a viewer with a series of advertising content in which the viewing history or the like of a viewer is reflected. Thus, advertising content that will not be boring to the viewer can be delivered.

In addition, using the present invention, since the advertisement delivery system, the advertising content and advertisement delivery apparatus, and the advertisement delivery method are configured such that, when viewers perform browsing operations upon receiving delivery of advertising content in a receiving device, browsing operations are recorded as viewing histories, trading activities of viewers are recorded as trading histories, and delivery of advertisements from the advertisement delivery system is recorded as delivery histories, the viewing history and the like of viewers can be utilized in various forms thereafter.

Furthermore, using the present invention, new advertising content can be generated based on acquiring information consisting of viewing histories, delivery histories, or trading histories, and information consisting of market trend information of specific markets set for each target user, and general market trend information. Thus, it is possible not only to effectively deliver advertising content, but also to pinpoint specific new markets that seem promising in future, one after another, and deliver advertisements without delay to new users belonging to the new market classes based on acquired information, current market trends and the like.

### BRIEF DESCRIPTION OF THE DRAWINGS

In the accompanying drawings:

FIG. 1 is a block diagram showing an entire advertisement delivery system according to the first embodiment of the present invention;

FIG. 2(A) is a block diagram showing a connection between advertising content to be delivered utilizing the advertisement delivery system of FIG. 1 and a WEB site;

FIG. 2(B) is a block diagram showing a connection between advertising content to be delivered utilizing the advertisement delivery system of FIG. 1 and other advertising content;

FIG. 3 is a block diagram showing an example of configuration of an advertisement delivery apparatus to be a part of the advertisement delivery system of FIG. 1;

FIG. 4 is a schematic view illustrating the entire configuration in detail of the advertisement delivery system of FIG. 1, infrastructure surrounding the advertisement delivery system and the like;

FIG. 5 is a block diagram illustrating the configuration of advertising content to be delivered utilizing the advertisement delivery system of FIG. 1;

FIG. 6 illustrates the linking of advertising content, which is a main part of the advertisement delivery system of FIG. 1, to other advertising content, and how the advertising content is located in a multi-layered structure;

FIG. 7 illustrates an image of access to each layer in which advertising content items are located, from the viewpoint of a viewer utilizing the advertisement system of FIG. 1;

FIG. 8 illustrates the social environment surrounding a viewer who receives advertisement delivery services using the advertisement delivery system of FIG. 1;

FIG. 9 is a block diagram illustrating flows of information such as each type of history, and a mechanism of mutual relationship of elements in operating the advertisement delivery system of FIG. 1;

FIG. 10 is a block diagram showing operational flows such as acquisition or the like of initial (first) delivery and viewing histories, before a viewer browses advertising content that is to be delivered to the viewer using the advertisement system of FIG. 1, and connects to a WEB site;

FIG. 11 is a block diagram showing operational flows such as acquisition or the like of second delivery and trading histories after a viewer browses advertising content, to be delivered to the viewer using the advertisement system of FIG. 1, and connects to a WEB site;

FIG. 12 is a block diagram showing configuration of an advertisement delivery apparatus according to the second embodiment of the present invention;

FIG. 13 is a block diagram showing configuration of an advertisement delivery apparatus according to the third embodiment of the present invention;

FIG. 14 is a block diagram showing configuration of an advertisement delivery apparatus according to the fourth embodiment of the present invention;

FIG. 15 is a block diagram showing configuration of an advertisement delivery apparatus according to the fifth embodiment of the present invention;

FIG. 16 is a block diagram showing configuration of an advertisement delivery apparatus according to the sixth embodiment of the present invention;

FIG. 17 is a block diagram showing configuration of an advertisement delivery apparatus according to the seventh embodiment of the present invention;

FIG. 18 is a block diagram showing configuration of an advertisement delivery apparatus according to the eighth embodiment of the present invention;

FIG. 19 is a block diagram showing configuration of an advertisement delivery apparatus according to the ninth embodiment of the present invention; and

FIG. 20 is a block diagram showing configuration of an advertisement delivery apparatus according to the tenth embodiment of the present invention.

### DESCRIPTION OF THE PREFERRED EMBODIMENTS

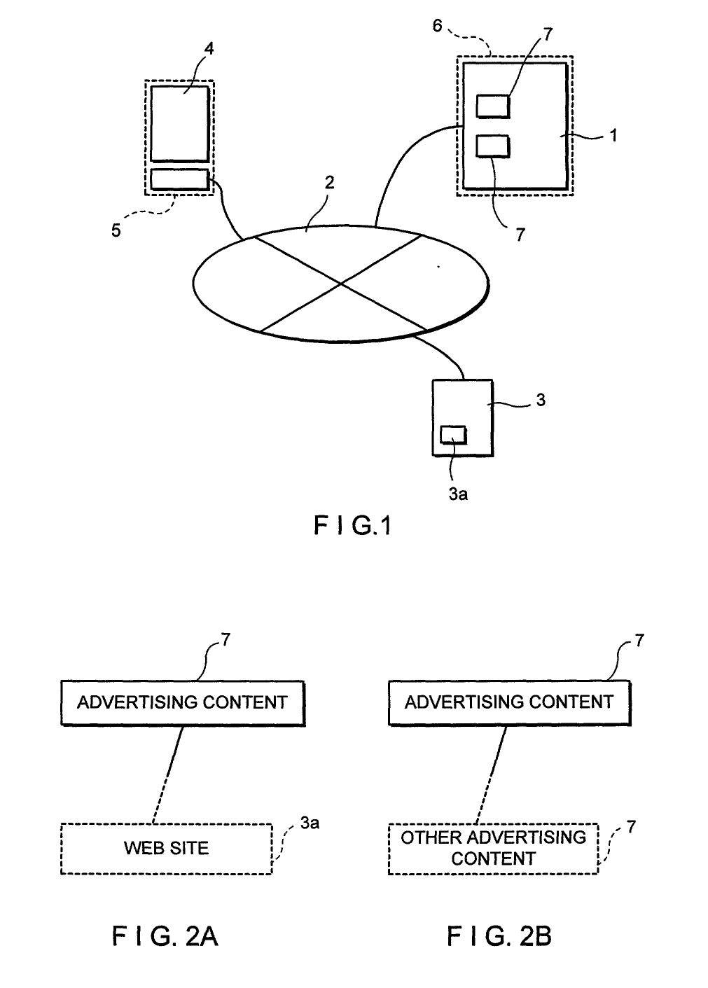

The first embodiment of the advertisement delivery system, advertising content and advertisement delivery apparatus and advertisement delivery method of the present invention is described with reference to FIGS. 1 through 11.

Furthermore, main features of the present invention are outlined below, before describing embodiments of the present invention.

A first feature of the present invention is that a viewer voluntarily receives delivery of advertising content (details of which are described later). A conventional advertisement is such as one unidirectionally delivered by a distributor, or one such as a banner advertisement from which a user (viewer) follows a link to reach a predetermined site or advertisement, and does not take the form of receiving delivery of advertisement itself.

A second feature of the present invention is that advertising content is completely different from conventional advertisements. Advertising content in the present invention includes an address section for linking to other advertising content or to a predetermined web site. Thus, upon receiving delivery of advertising content, a viewer can make a connection from the received content to other advertising content arranged on the Internet, or make a connection to a predetermined web page or site.

A third feature of the present invention is that advertising content can be accurately focussed on predetermined targets. In conventional advertisements, the target may be well targeted or not depending on the advertising content, but whether or not the targeting is appropriate cannot be checked. In the present invention—where targeted advertising content is delivered based on viewer delivery requests—delivery history and other kinds of histories are recorded, thereby improving accuracy of targeting the advertising content.

A fourth feature of the present invention is that it is possible to record various histories for advertising content. Most conventional advertisements end with the broadcast or reception, and data to evaluate their effectiveness or the like are hardly ever recorded, or are obtained by separately performing follow-up surveys at considerable expense.

In the present invention, it is possible to record the following four kinds of histories.

1. A viewing history at the time when a viewer receives delivery of advertising content, and browses the content.

2. A delivery history that is recorded when a viewer receives delivery of advertising content.

3. A delivery history recorded at the time when a viewer receives delivery of advertising content and browses the content, and makes a connection to a WEB site via an advertisement delivery apparatus for delivering advertising content.

4. A trading history recorded when a viewer receives delivery of advertising content and browses the content, and makes a connection to a WEB site utilizing the advertising content, and when the WEB site is a trading site and the viewer utilizes the trading site.

A fifth feature of the present invention is that the present invention can be applied widely not only to networks such as the Internet, but also to cable television, satellite broadcasts, telephone networks or the like—for example, cellular phones, various kinds of fast communication network and the like. The mechanism of advertising content in the present invention can also be applied to television programs. That is, for example, a thirty-minute program can be divided into ten three-minute program segments, and an accurate audience rating of the program can be obtained by recording the delivery history or viewing history of the content.

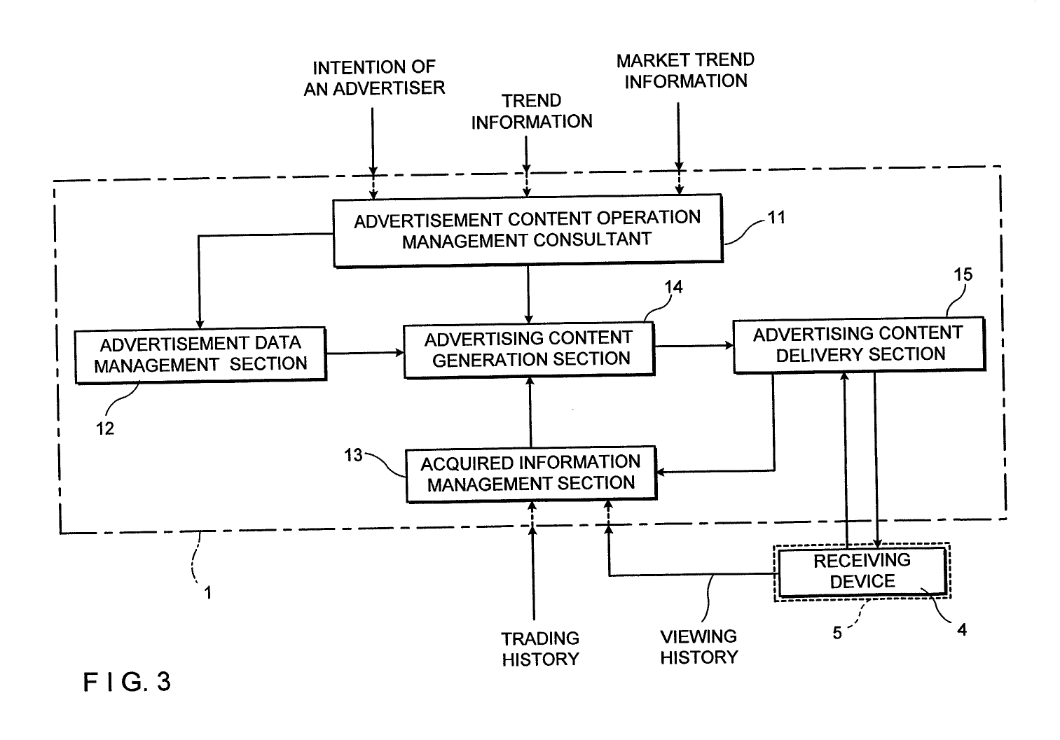

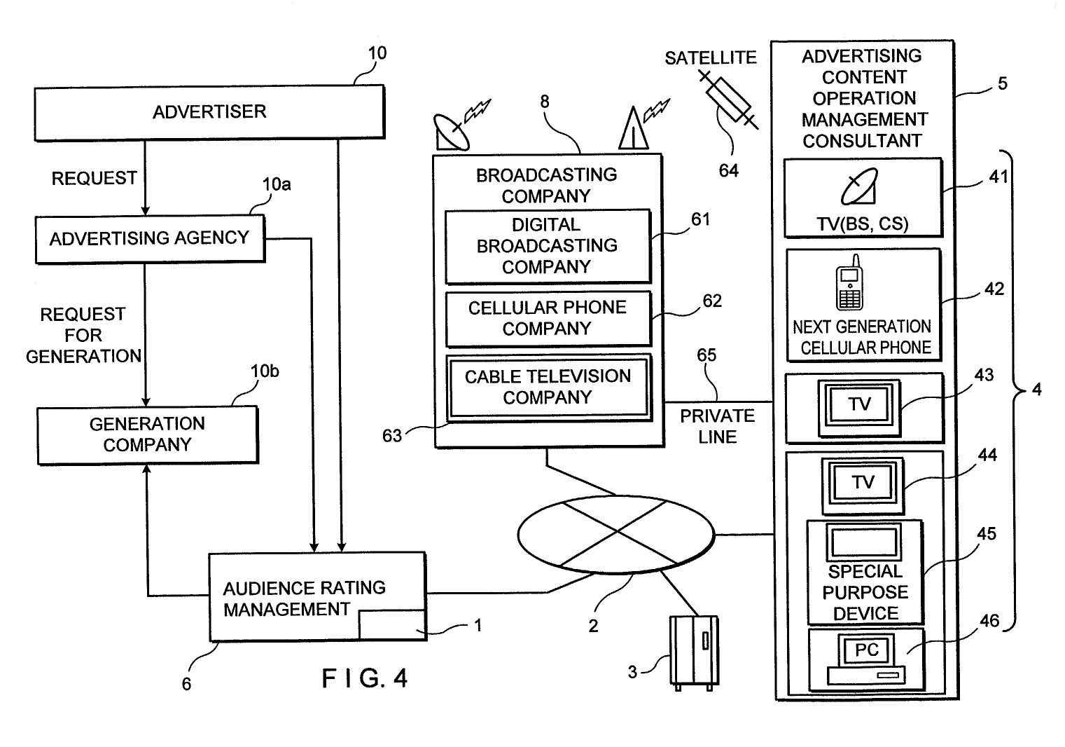

The block diagram in FIG. 1 shows an entire advertisement delivery system of the first embodiment of the present invention having the above-described features. FIGS. 2(A) and (B) block diagrams show connection relationships between advertising content to be delivered utilizing the advertisement delivery system of this embodiment and a WEB site or other advertising content. The FIG. 3 block diagram shows an example of configuration of an advertisement delivery apparatus to be a part of the advertisement delivery system of this embodiment. FIG. 4 is a schematic view illustrating the entire detailed configuration of the advertisement delivery system of this embodiment, infrastructure surrounding the advertisement delivery system and the like.

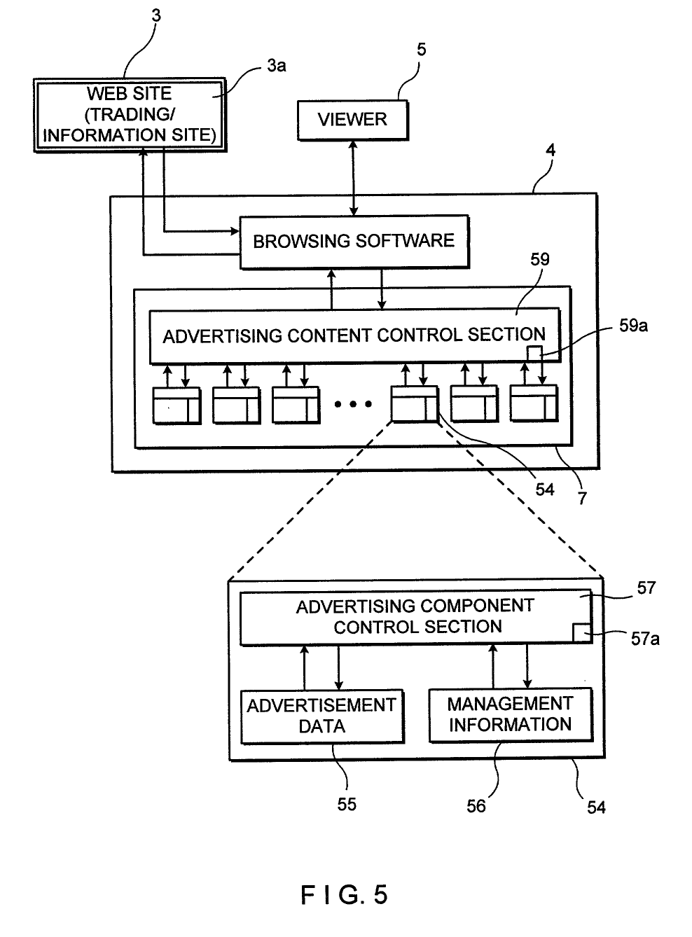

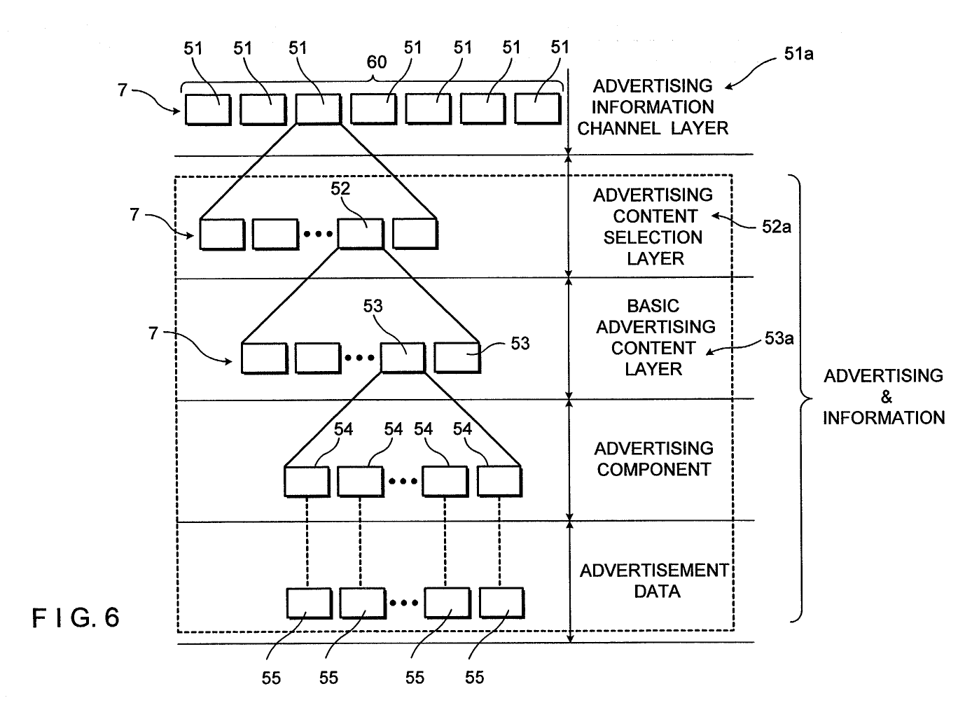

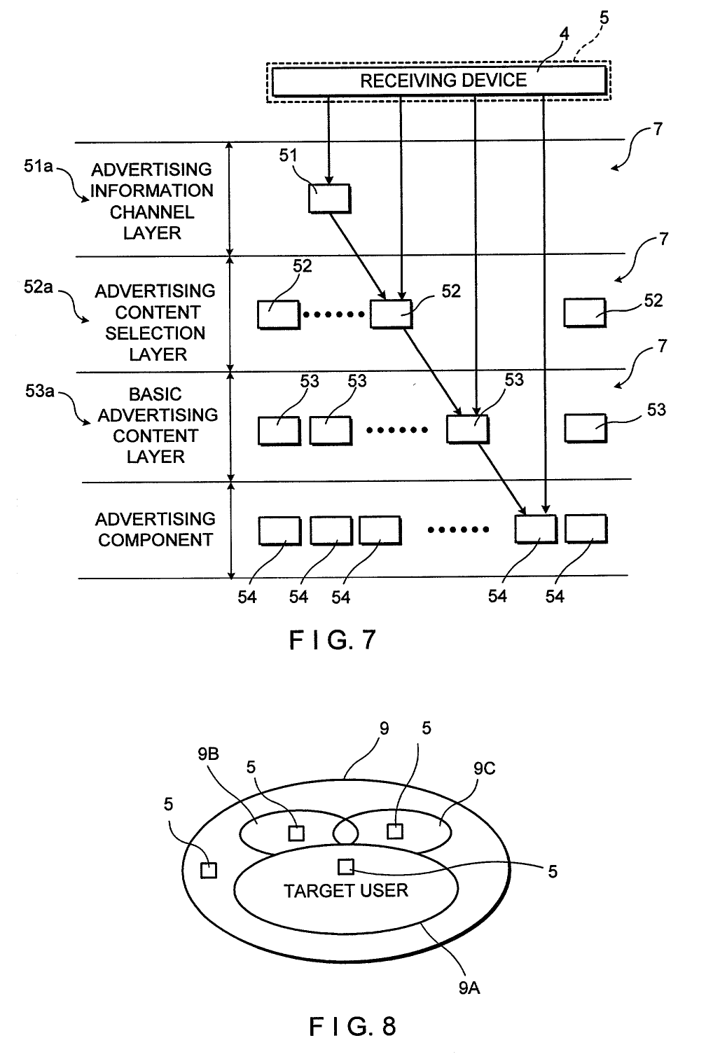

The FIG. 5 block diagram illustrates the configuration of advertising content in the advertisement delivery system of this embodiment. FIG. 6 illustrates layers when advertising content, which is a major part of the advertisement delivery system of this embodiment, is provided with a link relationship to other advertising content, and the advertising content is arranged in a multi-layered structure. FIG. 7 provides an image of access to each layer in which advertising content is arranged respectively from the viewpoint of a viewer utilizing the advertisement system of this embodiment.

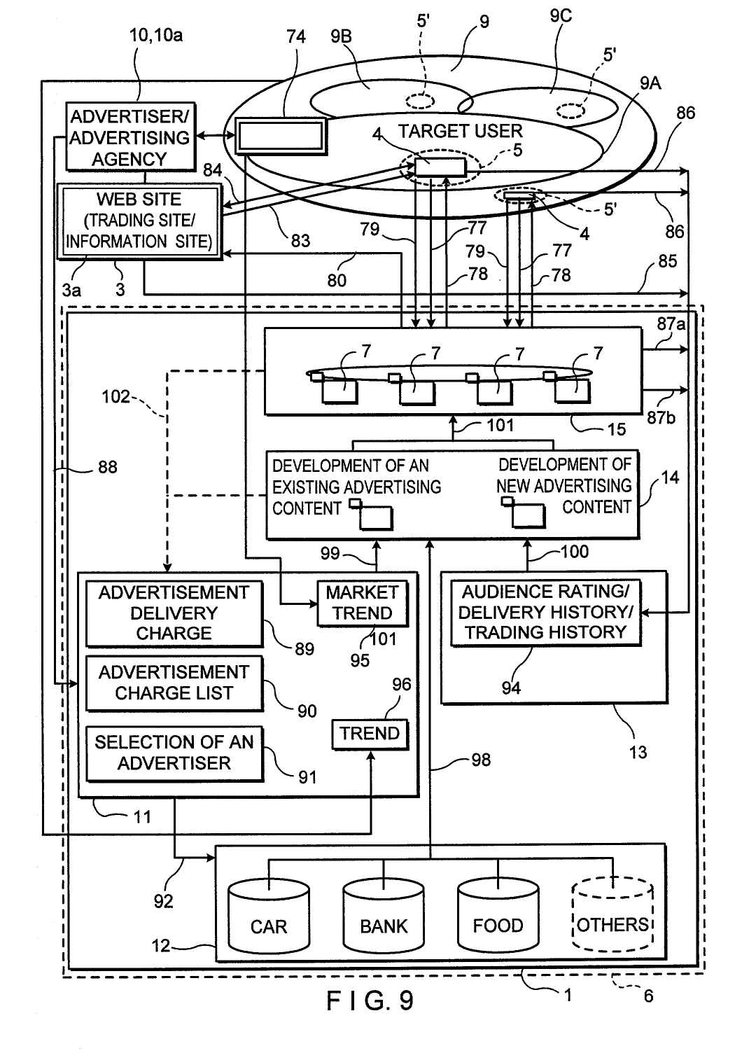

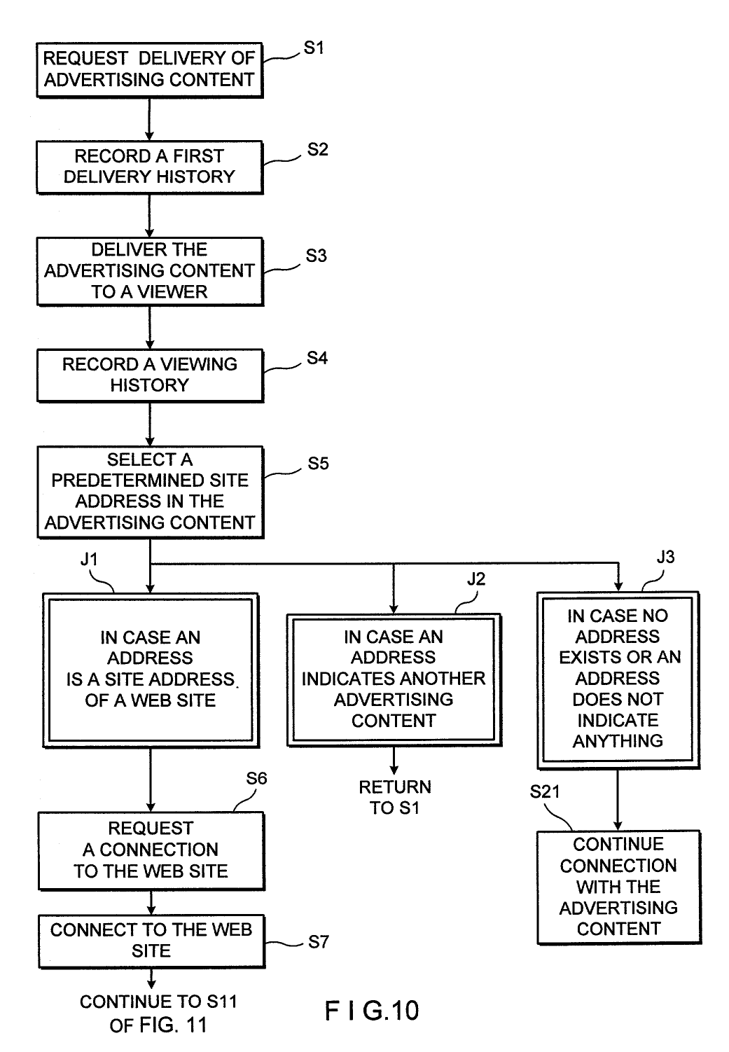

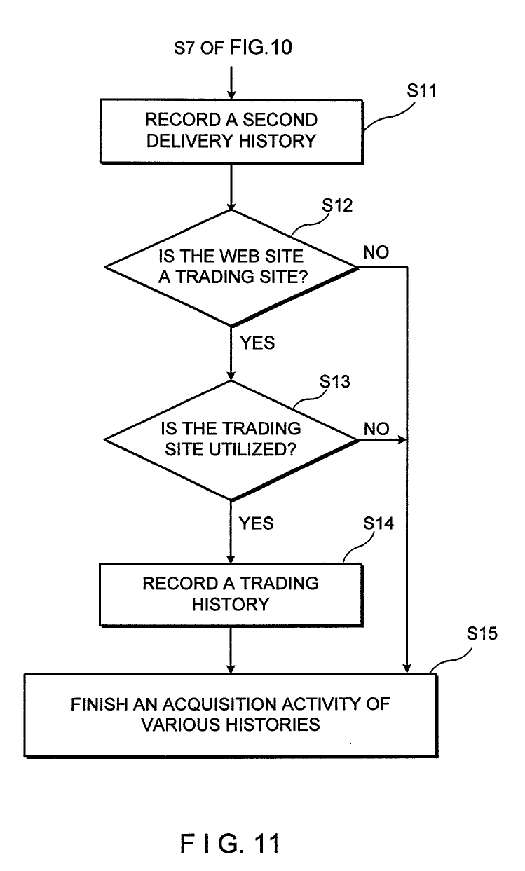

FIG. 8 illustrates the social environment surrounding a viewer who receives advertisement delivery services using the advertisement delivery system of this embodiment. The FIG. 9 block diagram illustrates flows of information such as each type of history and mutual interrelationship mechanisms in operating the advertisement delivery system of this embodiment. FIG. 10 is a block diagram showing operational flows such as acquisition or the like of both first delivery history and first viewing history before the viewer first browses advertising content to be delivered to the viewer using the advertisement system of this embodiment, and links to corresponding WEB sites. FIG. 11 is a block diagram showing operational flows such as acquisition or the like of each of the second delivery history and trading history after the viewer browses advertising content delivered to the viewer using the advertisement system of this embodiment, and links to corresponding WEB sites.

The advertisement delivery system of the first embodiment of the present invention comprises an advertisement delivery WEB server (hereinafter referred to as an advertisement delivery apparatus) 1 connected to a fast communication network 2, a WEB server in which WEB sites 3a are stored, and to which advertising content 7 is linked, for sites 3 connected to the fast communication network 2, and a receiving device 4 used by a viewer 5 to receive delivery of advertising content 7 from the advertisement delivery apparatus 1 via the fast communication network 2. Furthermore, although there are multiple WEB servers for sites 3 and multiple viewers 4 respectively, they are represented by just one WEB server for sites 3 and one viewer 4 in FIG. 1.

The advertisement delivery apparatus 1 is used by an advertisement delivery company 6, which manages the advertisement delivery system, to perform operational management of the advertising content 7. More specifically, advertising content 7 is located in advertisement delivery apparatus 1 connected to a fast communication network 2, in which various mixed advertisements such as advertisements of advertisers 10 (see FIG. 4) that are clients who request the advertisement delivery company 6 to operate the WEB site 3a for their own advertisements, and advertisements of the advertisement delivery company 6 itself, are generated and focussed on predetermined targets.

As described above, the advertisement delivery company 6 creates new advertising content 7 having one or more advertisements that are focussed on a predetermined target in advance, or adds new advertisements to, or deletes old advertisements from, existing advertising content 7 already arranged on the fast communication network 2 (hereinafter referred to as updating advertising content 7), and arranges them on the fast communication network 2.

Fast communication network 2 refers to fast Ethernet used for connection to the Internet, a CATV-cable based fast communication network, or the like. The WEB server for sites 3 stores WEB sites 3a such as WEB sites of advertisers 10 who have requested the advertisement delivery company 6 to operate its own advertisements and to which advertising content 7 is linked. Furthermore, the WEB server for sites 3 is not specifically limited to the one owned or managed by the advertiser 10. The receiving device 4 may be a personal computer, a television, one of various portable terminals, or the like that is connected the fast communication network 2.

Furthermore, “WEB site” 3a refers to all sites located on networks such as the Internet, and is divided into trading sites for performing trading activities and providing services, and all sites other than such trading sites (hereinafter referred to as information sites). A trading site in this context refers to a WEB site 3a which exists for the purpose of trading information, goods or services utilizing a fast communication network 2 consisting of fast Ethernet or the like. In addition, sites at which on-line trading cannot be performed but trading can be concluded utilizing other means, such as sites on which tokens are issued and goods can be obtained by taking the token to an actual shop, also fall under the category of trading sites. Sites other than trading sites fall under the category of information sites. For example, news sites or documentary program sites, chat sites, videophone conversation sites are included in information sites.

This outline of the advertisement delivery system refers to FIG. 1. The viewer 5 requests the advertisement delivery apparatus 1 to deliver advertising content 7 utilizing the receiving device 4. Then, the advertisement delivery apparatus 1 delivers the advertising content 7 to the receiving device 4 via a fast communication network 2. Furthermore, the advertising content 7 to be delivered is focussed on predetermined targets (details are described later), and is generated or customized for predetermined target users.

Then, as shown in FIG. 2(A), if an address part containing a link relationship with a WEB site 3a is included in delivered advertising content 7, the viewer 5 can make a connection to the WEB site 3a via the advertisement delivery apparatus 1 that delivers advertising content 7. In addition, as shown in FIG. 2(B), if an address part which contains a link to other advertising content 7 is included in the delivered advertising content 7, the viewer 5 can receive delivery of other advertising content 7 via the advertisement delivery apparatus 1 that delivers the advertising content 7.

Detailed configuration of the advertisement delivery apparatus 1 shown in FIG. 1 is illustrated in FIG. 3. The advertisement delivery apparatus 1 is provided with an advertisement generation element management section 11 for managing various elements for targeting advertising content to predetermined targets; an advertisement data management section 12 for accumulating and managing various kinds of advertisement data 55 (see FIG. 5) forming advertising content 7; an acquired information management section 13 for acquiring and managing viewing histories, delivery histories, and trading histories; advertising content generation section 14 for selecting optimum advertisement data 55 based on various generation elements or various kinds of acquired information and generating advertising content 7; and an advertising content delivery section 15 that contains the generated advertising content 7, delivers advertising content 7 to the receiving device 4 of the viewer 5 via a fast communication network 2, and is capable of recording delivery histories.

Various elements for targeting advertising content to a predetermined target which is managed by the advertisement generation element management section 11 consist of market trend information on the specific market to which the user group which is a target of the advertising content 7 belongs, trend information of the wider market to which the user group belongs, intentions of the advertiser 10 who is the client, or the like. In addition, advertisement data 55 accumulated and managed by the advertisement data management section 12 consists of data such as still or moving images, and voice data or the like for displaying various advertisements.

In addition, viewing histories acquired by the acquired information management section 13 of the advertisement delivery apparatus 1 refer to histories to be recorded when the viewer 5 receives delivery of advertising content 7 and browses the advertising content 7 using the receiving device 4. Viewing histories are designed to be recorded on the receiving device 4 side. Then, recorded viewing histories are sent to the acquired information management section 13 of the advertisement delivery apparatus 1 from the receiving device 4, and managed by the acquired information management section 13.

In addition, delivery histories to be acquired by the acquired information management section 13 of the advertisement delivery apparatus 1 include histories to be recorded by the advertisement delivery apparatus 1 when advertising content 7 is delivered to the receiving device 4 of the viewer 5 from the advertisement delivery apparatus 1, and histories to be recorded by the advertisement delivery apparatus 1 when the viewer 5 makes a connection to a WEB site 3a that is linked to the delivered advertising content 7 utilizing links contained in the address part of the advertising content 7. These delivery histories are recorded by the advertisement delivery section 15, and the recorded delivery histories are sent to the acquired information management section 13 and managed in the acquired information management section 13.

In addition, trading histories acquired by the acquired information management section 13 of the advertisement delivery apparatus 1 are recorded as information that the viewer 5 records utilizing a trading site when the delivered advertising content 7 is connected to a WEB site 3a that is linked to advertising content 7 via the advertisement delivery apparatus 1, or when the viewer 5 having made connections to the WEB site 3a via the advertisement delivery apparatus 1 at least one or more times directly makes a connection to the WEB site 3a but not via the advertisement delivery apparatus 1, in—for example—second and subsequent connections, and the connected WEB site 3a is a trading site. Trading histories are recorded on the trading site side, sent to the acquired information management section 13 of the advertisement delivery apparatus 1 from the trading site by some method, and managed in the acquired information management section 13. Furthermore, utilization of the trading site in this context is not limited to trading activities themselves by on-line trading or other methods, but includes activities relating to trading such as requests for estimates and requests for browsing product catalogues.

Furthermore, although two kinds of delivery histories consisting of histories to be recorded by the advertising content delivery section 15 when advertising content 7 is delivered to the receiving device 4 of the viewer 5 and histories recorded when the delivered advertising content 7 results in a connection to a WEB site 3a that is linked to the advertising content 7 via the advertisement delivery apparatus 1 in this embodiment, the advertising content delivery section 15 may be either of these two kinds of delivery histories.

In addition, in this embodiment, viewing history and trading history are configured to be recorded in the receiving device 4 and the WEB site 3a respectively, and to be directly sent together to the acquired information management section 13 of the advertisement delivery apparatus 1. However, the histories may be sent to the acquired information management section 13 via other parts of the advertisement delivery apparatus 1.

In addition, the acquired information management section 13 is configured to collect and manage all of the four histories, namely, viewing histories, the two kinds of delivery histories consisting of histories recorded when advertising content 7 is delivered to viewers and histories recorded when delivered advertising content 7 results in connection to WEB sites 3a that are linked to the advertising content 7 via the advertisement delivery apparatus 1, and trading histories. However, the acquired information management section 13 may be configured to collect and manage, for example, only one of the four histories, or two or three of them.

The advertising content generation section 14 receives acquired information such as viewing histories from the acquired information management section 13, and creates advertising content 7 that is focussed on predetermined targets, considering the acquired information and various elements such as market trend information managed by the advertisement generation element management section 11. That is, advertisement data 55 that match a predetermined target are extracted from the advertisement data management section 12 and combined to create advertising content 7 that is focussed on the predetermined target. Furthermore, targeting is performed based on at least one of: predetermined genre, predetermined category or predetermined concept. The advertising content 7 configured in this way is delivered to the receiving device 4 of the viewer 5 from the advertising content delivery section 15 via a fast communication network 2.

The following is a description of the detailed configuration of an advertisement delivery system provided with advertising content 7, completely different from conventional advertising content and having an address part containing links and programmed to collect viewing histories or the like, and an advertisement delivery apparatus 1 having the function of creating entire advertising content 7, and infrastructure for operating the system. FIG. 4 is a schematic view illustrating the entire detailed configuration of the advertisement delivery system of the first embodiment of the present invention, infrastructure surrounding the advertisement delivery system and the like.

As described in FIG. 1, the advertisement delivery apparatus 1, the WEB server for sites 3 containing the WEB site 3a and the receiving device 4 of the viewer 5 are connected to a fast Internet communication network 2. In addition, in this advertisement delivery system, broadcasting companies 8 and advertisement delivery companies 6 forming part of the advertisement delivery apparatus 1 are connected to a fast communication network 2 as shown in FIG. 4.

Furthermore, fast Internet network(s) refers to fast networks such as Ethernet which may include satellites, fast wireless LANs and fast LANs, and which are connected to the Internet. The speed of the Ethernet in this embodiment is assumed to be that of fast Ethernet, gigabit Ethernet, Terabit Ethernet, or even faster.

In addition, the receiving device 4 of the viewer 5 is what is called an Internet device, and is an input/output device that can be connected to the Internet, and includes image display equipment. For example, the receiving device 4 is a television that is capable of receiving digital broadcasts 41 such as BS digital broadcasts, CS digital broadcasts and ground-wave digital broadcasts from digital broadcasting companies 61, cellular phones, portable terminal devices (not shown) or a next-generation cellular phones 42 that are capable of transmitting and receiving voice data, character data, image data or the like to and from a cellular phone company 62, televisions 43 for receiving cable television broadcasts 43 and connected to a cable television company 63 by private cable 65, Internet television viewers 44, special-purpose devices 45 that are developed for this advertisement delivery system, personal computers 46, or the like. Furthermore, “next generation cellular phones” 42 are assumed to be cellular phones having fast communication functions and the capability of processing large quantities of images at high speed.

In addition, special-purpose devices 45 for this advertisement delivery system are capable of delivering advertising information and advertising programs or performing bi-directional services by connecting to an Internet network. Examples of special-purpose devices 45 could be devices or the like that are installed in shops, outdoors, or in trains, and perform advertising services or the like.

The broadcasting company 8 assumes part of the functions of the advertisement delivery apparatus 1 in this advertisement delivery system, and delivers various kinds of data including advertising content 7 to the receiving device 4. The term broadcasting company 8 generally refers to a company that delivers images, audio (voice) or other information, or offers bi-directional services to the viewer 5. More specifically, broadcasting companies 8 include digital broadcasting companies 61, cellular phone companies 62, cable television companies 63 and the like as described above.

Furthermore, as shown in FIG. 4, a client who requests an advertisement delivery company 6 to deliver advertisements utilizing the advertisement delivery system could be an advertiser 10 or an advertising agency 10a. That is, advertiser 10 refers to a person or a company that wishes to place an advertisement—for example, a person or a company that requests an advertisement delivery company 6 to deliver its advertisements to WEB sites 3a composed of information sites or trading sites. Furthermore, advertising agency 10a refers to advertisement trading companies. In addition, generation company 10b illustrated in FIG. 4 refers to the company that creates actual advertisements (advertising (images), other advertisement data, etc.) information upon receiving requests from advertisers 10, advertising agencies 10a, advertisement delivery companies 6 or the like.

Advertising content 7 is described in detail with reference to FIGS. 5 and 6.

First, outlines of functions of the advertising content 7 generated in the advertisement delivery device 1 are described. That is, the advertising content 7 is configured to have a clear target user and is suitable for the market which is the target of the advertisement. The advertising content 7 has one or more advertising components 54 and is a final unit, one advertisement, in which management information 56 is added to advertisement data 55, and (to be focussed on a predetermined target) it is classified into at least one of: a predetermined genre, a predetermined category or a predetermined concept and is configured with an arbitrary delivery time.

Furthermore, the advertising component 54 has an address part for realizing access to a predetermined WEB site 3a or the like. In addition, the advertising component 54 has an event (program) for requesting connection to an address such as a WEB site 3a or the like. The advertising content 7 starts operation of advertising content control section 59 under control of the address part and the connection requesting event (program), and can be linked to another WEB site 3a or the like under the control of the advertising content control section 59. Furthermore, the address part of the advertising component 54 is located in the management information 56 shown in FIG. 5, and is controlled by the connection requesting event (program) of the advertising component control section 57. Although the advertising component 54 is configured to operate as described above in this embodiment, the advertising component 54 may be programmed such that the address part and the connection requesting event (program) directly connect to the WEB site 3a or the like, not via the advertising content control section 59.

In addition, the advertising content 7 also has the function of saving various kinds of information such as delivery date and time of a viewed advertisement, the advertisement viewed last, and the like. In addition, advertising content 7 has the function of updating advertising content 7 browsed by the viewer 5 to the latest advertisement whenever necessary (an updating function). Furthermore, as a part of the updating function, the viewer 5 can select whether the advertising content 7 is automatically updated, or updated after the viewer 5 is asked if it is OK or not to update the advertising content 7 when the advertising content 7 has been updated, or only updated when the viewer 5 voluntarily selects the updating of advertising content 7.

Furthermore, in some cases, advertising content 7 having the above-mentioned functions is composed of one advertising component 54 or a multiplicity of advertising components 54. Moreover, although FIG. 6 is based on this assumption, the number of advertising components 54 provided in the advertising content 7 may be only one.

In addition, the advertising content 7 can be linked to one or more other items of advertising content 7. Then, advertising content 7 in the link relationship will have a relationship in which the advertising content 7 is arranged in a multi-layered structure, and each advertising content item 7 can be located in any layer of the multi-layered structure. That is, although only the address part of each advertising content 7 can indicate link relationships between the advertising content 7 and other advertising content, the viewer 5 can see that the advertising content 7 itself is arranged in a multi-layered structure. Furthermore, the advertising content 7 can have multiple address parts, and each advertising component 54 may have one or many address parts.

FIG. 6 illustrates layers of advertising content 7 indicating as a general image that advertising content 7 is arranged in a multi-layered structure, advertising content 7 arranged in upper layers is linked to multiple content items 7 arranged in lower layers, and advertising content 7 arranged in the lowermost layer may be formed of multiple advertising components 54 as shown. As shown in FIG. 6, each advertising content 7 is arranged in any one of the layers in the multi-layered structure. That is, each of the advertising content items 7 arranged in the upper layers contains an address part that is linked to advertising content 7 arranged in the lower layers. The advertising content 7 arranged in upper layers are generalized by relatively large concepts. In contrast, the advertising content 7 arranged in the lower layers are generalized by relatively small concepts. Thus, when receiving delivery of advertising content 7 that is linked to the advertising content 7 in the lower layers among the advertising content 7 arranged in the upper layers, the viewer 5 can shift from advertising content 7 to lower layers while targeting concepts to the advertising content 7.

Furthermore, individual advertising content 7 is hereinafter described for each layer by attaching a name to each of the advertising content items 7 arranged in the layer. Any individual advertisement existing in each layer is advertising content 7 in the context of the present invention. That is, advertising channel 51, advertising content selection 52, and basic advertising content 53 positioned in the lowermost layer are all advertising content items 7.

Furthermore, among the advertising content 7 arranged in each layer, there exists advertising content 7 that has one or both of an address part that is linked to a WEB site 3a relating to the advertising content 7 and an address part that is linked to other advertising content 7. In other words, all the advertising content 7 are those having the above-mentioned address parts in some cases, or a part of the advertising content 7 that does not have the above-mentioned address part at all in other cases. The viewer 5 can shift from advertising content 7 having the above-mentioned address part to other advertising content 7 or a WEB site 3a that is linked to the advertising content 7 utilizing the address part.

In FIG. 6, an advertising information channel 51a shown in the uppermost layer is a layer in which an advertising channel 51 for specially handling an advertisement set by the above-mentioned broadcasting company 8 (see FIG. 4) is arranged, and the viewer 5 can shift from the advertising channel 51 of this advertising information channel layer 51a to an advertising content selection layer 52a positioned in a lower layer. That is, when the viewer 5 selects one advertising channel 51 and receives it, since multiple address parts that are linked to advertising content selections 52 in a lower layer are arranged in the advertising channel 51, upon selecting one of the address parts, the viewer 5 receives delivery of advertising content selection 52 to which the selected address part is linked. Furthermore, the broadcasting company 8 may arrange a program or the like that is linked to the advertising content selection 52 in the advertising information channel layer 51a by a unique method without using the advertising channel 51.

In addition, the viewer 5 can shift from the advertising content selection layer 52a to a basic advertising content layer 53a positioned in a lower layer, its lowermost layer. Furthermore, although in FIG. 6 the advertising component 54 is shown to be arranged in a lower layer than the basic advertising content 53 in the lowermost layer, and the advertisement data 55 is shown to be arranged in an even lower layer, these are regarded not to be arranged in the lower layers but are part of the basic advertising content 53. In addition, as described above, the advertising channel 51 and the advertising content selection 52 are individual advertising content items 7 provided with the advertising component 54 and the advertisement data 55 in FIG. 6.

The advertising channel 51 is made to be displayed in the form of multi-windows on, for example, a display screen of the receiving device 4 used by the viewer 5. When the viewer 5 selects an arbitrary one of multiple advertising channels 51 arranged on a program selection screen 60 (see FIG. 6) of the display screen, the viewer 5 is connected to the advertising channel 51 that is provided with an address part that is linked to multiple advertising content selections 52.

Then, when the viewer 5 selects any one of the advertising content selections in the advertising channel 51, the viewer 5 is connected to the advertising content selection 52 that is provided with an address part that is linked to multiple basic advertising content items 53. Then, when the viewer 5 further selects a predetermined basic advertising content 53 in the advertising content selection 52, the viewer 5 can browse the desired basic advertising content 53.

Furthermore, some advertising content 7 may exist which has an address part linked to other advertising content 7 arranged in the same layer or an upper layer instead of an address part linked to other advertising content 7 arranged in a lower layer. Although it is preferable to configure advertising content 7 such that an address part that is linked to a WEB site 3a or other advertising content 7 is provided in one or more advertising content items 7 arranged in any one of the layers, advertising content 7 that is not linked to other advertising content 7 may be mixed in the above-mentioned multi-layered structure, or the advertising content 7 may be configured as content that is neither arranged in the multi-layered structure nor has any link relationships.

Here, an access layer and its operational management of the advertising content 7 is described. The viewer 5 can receive advertising information via multiple access routes such as selecting from among multiple advertising content items 7 or designating a specific advertising component 54. FIG. 7 shows an image of how each layer is accessed to realize the receipt of advertising information.

As described above, advertising channel 51 means a channel established by a digital broadcasting company 61 or a cable television company 63 for specially handling advertising information as “transmission lines”. In this embodiment, what the viewer 5 does to receive delivery of advertising content 7 via a digital broadcasting company 61 or a cable television company 63 is to start by first selecting a predetermined advertising channel 51 from the advertising information channel layer 51a that is the channel for specially handling advertising information.

Furthermore, in addition to a single act of receiving delivery of the advertising channel 51 that is equivalent to receiving delivery of advertising content 7, an act of receiving delivery of advertising content 7 of lower layers (which means advertising content selection 52 and basic advertising content 53) one after another while shifting further to lower layers, which is also referred to as an act of receiving delivery of advertising content 7. That is, a channel layer that specially handles advertising information may exist as one form of a general TV channel, and the advertising channel 51 itself in the channel layer or the entire advertising information channel layer 51a may be regarded as advertising content 7.

In addition, the advertising content selection 52 refers to advertising content that is focussed on a predetermined genre, category, concept or the like, and is linked to at least one or more basic advertising content items 53 associated with contents of the focussing/targeting. Furthermore, the advertising content selection 52 may be advertising content that is focussed/targeted by any one of: genre, category, concept or the like, or may be focussed by a combination of two or more of: genre, category and concept. The viewer 5 is able to select an advertising content selection 52 that is consistent with the viewer's own desire, from multiple advertising content selections 52 focussed on predetermined genres or the like.

In addition, basic advertising content 53 arranged in the lowermost layer is composed of one or more advertising components 54 as described above, and represents the smallest unit of an advertising program having a predetermined amount of advertising information that is classified as at least one item (or, in some cases, a combination with multiple items) of a predetermined genre, category and concept. Furthermore, in this embodiment, the basic advertising content 53 arranged in the lowermost layer is configured to have an address part linked to at least one or more WEB sites 3a, and when receiving delivery of basic advertising content 53, the viewer 5 can make a connection to a WEB site 3a via the advertisement delivery apparatus 1 that delivers the basic advertising content 53.

In addition, as shown in FIG. 5, the advertising component 54 is data in which the management information 56 is added to the advertisement data 55, and the management information 56 includes site address, control data and the like. The management information 56 and advertisement data 55 are controlled by the advertising component control section 57. In addition, an audience rating management program 57a for managing audience rating is stored in the advertising component control section 57. Furthermore, the audience rating management program 57a may be divided and arranged in the advertising content control section 59 in addition to the advertising component control section 57.

Furthermore, although the advertising component 54 is illustrated as belonging to the basic advertising content 53 arranged in the lowermost layer in FIGS. 6 and 7, advertising component 54 is also provided in advertising channels 51 and advertising content selections 52 in a similar manner. In addition, in some cases, only one advertising component 54 forms the basic advertising content 53, the advertising content selection 52 and the advertising channel 51.

Functions of each main part forming the advertisement delivery system will now be described in detail.

Main function of the advertisement delivery apparatus 1 is to create and update advertising content 7, and to deliver it to the viewer 5. Clear target user layers are provided in the advertising content 7 delivered to the viewer 5. That is, a characteristic of each advertising content 7 is that the advertising content 7 has an active (direct) advertisement configuration that is associated with a clear genre, category or concept for accurate targeting to users. In addition, the advertising content 7 has an advertisement configuration in which intentions of target users, market trend information, trend information (trend) of the wider market held by the advertiser 10, and the intentions of the advertiser 10, are considered.

It is an object of advertising information services provided by the advertising content 7 generated by the advertisement delivery apparatus 1 to have the advertising content 7 utilized as the advertisement medium for connecting the viewer 5 and, for example, a trading site or an information site to be the WEB site 3a for displaying advertisements of the advertiser 10.

A characteristic of this advertising information service is that the current advertisement's publicity effect can be quantitatively evaluated utilizing the function of acquiring the above-mentioned viewing history, delivery history and trading history held by the advertisement delivery apparatus 1. Furthermore, for example, the function of automatically acquiring the various above-mentioned kinds of information, thereby utilizing the acquired information to create advertising content 7, may be included in the advertisement generation function held by the advertisement delivery apparatus 1. With such an automatic generation function, the advertisement delivery apparatus 1 creates a new market or further narrows focus on a target, and corresponding advertising content 7 is automatically generated.

Moreover, a retrieving function may be included in the automatic generation function. With such a retrieving function, when the viewer 5 actively retrieves an advertisement that the viewer 5 wishes to view, new advertising content 7 which reflects the retrieval results is generated. Then, the viewer 5 can browse the advertising content 7 generated by voluntarily retrieving the advertisement. More specifically, the retrieval results can be browsed as advertising content 7 by inputting keywords of a predetermined genre, category, concept or the like, selecting a retrieval button, or the like. That is, by incorporating an active act of “retrieving”, more positive enclosure (with sense of purpose) of users becomes possible.

Furthermore, the above-mentioned characteristic of the advertisement delivery apparatus 1 is based on the fact that advertising content 7 having one or more pieces of advertisement data 55 focussed on a predetermined target is delivered to the viewer 5. Thus, even when each of the above-mentioned additional functions (the automatic generation function and the retrieving function) are not provided, the functions and effectiveness of the advertisement delivery apparatus 1 are still evident. The automatic generation function and the retrieving function in this function are functions that are supplementarily reinforced versions of the characteristic held by the advertisement delivery apparatus 1.

Then, the advertising content 7 and the advertising component 54 as well as the role and function of the advertisement delivery apparatus 1 with respect to the advertising component 54 are described with reference to FIG. 5.

As described above, advertising content 7 contains multiple advertising components 54 that represent the smallest unit used to make up an advertisement, and is configured with an arbitrary delivery time. The advertising content 7 has the function of allowing the advertising content 7 to be viewed (including functions for allowing videos or audio to be “replayed”, “stopped”, “fast-forwarded”, “rewound”, “skipped” and so forth). This function is provided in the advertising content control section 59 of the advertising content 7.

One advertising component 54 may represent one advertisement, or multiple advertising components 54 may represent one advertisement. When multiple advertising components 54 form one advertisement, it is necessary to successively deliver these advertising components 54 as a series. Such control is performed in the advertising content control section 59. Thus, the viewer 5 can recognize the advertising components 54 as one advertisement irrespective of the fact that the advertisement is composed of multiple advertising components 54.

Furthermore, concerning configuration for such advertising content 7 and advertising components 54; information to be delivered by the advertising content 7, in particular, does not need to be limited to advertising information, but in a similar manner can be information other than advertisements. For example, advertising content 7 and advertising components 54 may have a configuration in which advertising content equivalent to the advertising content 7 is generated as information program content and the information program content may have multiple information components that each represent a basic unit of information. Then, such information content may be received by a receiving device such as an Internet television.

As in the configuration of the advertising content 7, the information program content has the function of allowing information program content to be viewed (including functions for allowing videos or audio to be “replayed”, “stopped”, “fast-forwarded”, “rewound”, “skipped” and so forth), and is configured to have a control section corresponding to the advertising content control section 59 for controlling the function.

Furthermore, one above-mentioned information component may represent one information program, or multiple above-mentioned information components may represent one information program. When one information program is composed of multiple information components, it is necessary to successively deliver these information components in a series. Such control is performed in the above-mentioned control section. Thus, the viewer 5 can recognize the information components as one information program irrespective of the fact that the information program is composed of multiple information components.

More specifically, one information program of thirty minutes can be divided into ten information components each with a unit of three minutes, which are replayed one after another under the control of the control section in the information program content. Thus, the viewer 5 can browse the information components as a consecutive thirty-minute information program. Furthermore, an address part may be provided in the information component of the information program, and linked to a WEB site 3a such as an information site or a trading site; i.e. a site address, relating to images, audio or the like which make up the information component; or the information component may be configured such that viewing history, delivery history or the like can be recorded. Thus, it is possible to measure accesses to the WEB site 3a via a delivery apparatus for delivering the above-described information program content and an audience rating.

Furthermore, the configuration of the content and components, and examples of information program content have been described, and the configuration may be applied to any information regardless of the type of the information. That is, any kind of information can be delivered in a form similar to the advertising content 7 and the advertising components 54 as long as the information can be received by an Internet device. In addition, although images and audio are described as data forming the information component in the above-mentioned example, data may be images and/or audio. In addition, images may be still or moving images.

Advertising content 7 will now be described in detail.

The method of browsing advertising content 7 differs depending on the form of the receiving device 4 of the viewer 5. Advertising content 7 has the function of browsing advertisement data 55 held by the advertising component 54, and then realizing a connection to a WEB site 3a or other advertising content 7 from the advertising component 54. In addition, advertising content 7 has the function of selecting a request for connection to a WEB site 3a via an advertisement delivery apparatus 1 that delivers advertising content 7, and the function of saving information such as delivery date and time, and viewed advertisement data 55 and advertisement data 55 that was last viewed in one or both of management information 56 and advertising content control section 59. That is, advertising content 7 is programmed to realize the above-mentioned functions.

In addition, advertising content 7 has the function of delivering an audience rating management program and incorporating it in the receiving device 4 if the receiving device 4 of the viewer 5 does not have an audience rating management program, and the function of controlling start up or the like of the audience rating management program incorporated in the receiving device 4.

That is, advertising content 7 is programmed such that, when the viewer 5 receives the advertising content 7 by the receiving device 4 that the viewer 5 uses and browses the advertising content 7, the browsing operation is recorded as viewing history. That is, in this embodiment, advertising content 7 is programmed such that, when the viewer 5 receives delivery of advertising content 7 and browses advertising content 7, viewing history is recorded by storage means such as memory or hard disk of the receiving device 4. In addition, advertising content 7 is programmed such that viewing history recorded by the receiving device 4 is transmitted from the receiving device 4 to the advertisement delivery apparatus 1. Furthermore, the advertising component control section 57, provided with the audience rating management program 57a for realizing this, is provided in the advertising component 54, and audience rating 59a based on the viewing history is provided in the advertising content control section 59 of the advertising content 7.

Furthermore, it is desirable that advertising content 7 is programmed to record viewing history if a browsing operation continues for a predetermined period of time or more after the receiving device 4 receives the advertising content 7. This is because the viewer 5 is not so interested in the advertising content 7 in many cases if the viewer 5 immediately makes a connection to a WEB site 3a or other advertising content 7 after receiving the delivery, and such viewing history, if recorded, does not represent the true situation.

Furthermore, in this embodiment, advertising content 7 is set to record connection information (information such as site address of connection destination) of WEB site 3a as delivery history if a connection is made to the WEB site 3a via the advertisement delivery apparatus 1 for delivering advertising content 7.

In addition, in this embodiment, utilization information of a WEB site 3a is recorded on the trading site side as trading history if a connection is made to the WEB site 3a via the advertisement delivery apparatus 1 for delivering advertising content 7, WEB site 3a is the trading site, and the viewer 5 performs acts of requesting an estimate, trading or the like utilizing the WEB site 3a. The trading history is sent to the advertisement delivery apparatus 1 from the trading site side by some method. However, the advertising content 7 may be programmed such that the act of recording the trading history is performed on the advertisement delivery apparatus 1 side.

On the other hand, as described above, the advertising component 54 has, as a function, a site address (synonymous with the above-mentioned address part) for realizing a site connection from the advertising component (videos, still images, titles) 54 that the viewer 5 is viewing and an event (program) for requesting a connection to the site address. Furthermore, the site address included in the advertising component 54 may be multiple instead of single.

As shown in FIG. 5, data structure of the advertising component 54 is such that management information 56 is added to advertisement data 55, and the advertising component control section 57 controls them. The management information 56 includes site address, control data (information for overall management of advertisements such as advertisement data management number), or the like. The advertisement data 55 is the advertisement itself and means conventional (existing) advertisement data; and each piece of data is composed of at least one or more of pieces of information relating to moving images, still images or sounds.

The advertising component control section 57 includes a site address connection requesting event (program), a program for associating the advertisement data and the management information 56 for starting up each program, the above-mentioned audience rating management program 57a, and an interface to the advertising content control section 59 in the advertising content 7.

The advertising component 54 provided with the above-mentioned data configuration has a function capable of linking to a WEB site 3a associated with the advertisement data 55 by the act of selecting the advertisement data 55 composed of videos, still images, titles or the like that the viewer 5 is browsing.

Furthermore, the above-mentioned advertising content 7 may be browsed by special-purpose browsing software (a special-purpose browser) which is delivered to the receiving device 4, or may be browsed by general-purpose browsing software (a general-purpose browser). In addition, the advertising content 7 may be programmed such that, when the advertising content 7 is browsed by a special-purpose browser, the special-purpose browser is sent to the advertisement delivery apparatus 1 after its viewing history is recorded. Furthermore, delivery of a special-purpose browser may require confirmation by the viewer 5 (as to whether or not to deliver it) each time it is to be delivered, instead of delivering it automatically. In addition, delivery of software for acquiring and sending viewing history to the receiving device 4 may be performed at the same time as the special-purpose browser is delivered, or may be performed separately from the delivery. Furthermore, viewing history is recorded on the receiving device 4 side when browsing the advertising content 7 utilizing a general purpose browser instead of the above-mentioned special-purpose browser, and the viewing history is sent to the advertisement delivery apparatus 1.

Furthermore, as a form of advertising content 7, for example, publicizing the advertising content 7 itself, publicizing advertising content 7 to be arranged in an upper layer above the advertising content 7 or the like is possible, in addition to the above-mentioned one in which advertisements are provided by advertisers 10.

Moreover, as a form of advertising content 7, publicizing a medium other than the above-mentioned advertising channel 51, for example, placing an advertisement of a digital broadcast program or the like is possible. In addition, if the advertisement delivery apparatus 1 is provided with a function for automatically creating advertising content 7—as a form of advertising content 7—it is possible to automatically generate advertising content 7 utilizing the automatic generation function or the like. In addition, if the advertisement delivery apparatus 1 is provided with an automatic generation function and a retrieving function, advertising content 7 retrieved and generated by a selection or the like of the viewer 5 utilizing each of these functions is possible as a form of advertising content 7.

Unlike banner advertisements that are displayed on conventional web sites, advertising content 7 consists of only advertisements in their entirety, is mostly occupied by advertising information, and makes full use of consecutive videos, still images or the like. Advertising content 7 is configured such that, when a predetermined part of a video or a still image is selected, the viewer 5 directly jumps to a WEB site 3a or other advertising content 7 in which a group of goods related to the part is listed, or each advertising content 7 may have multiple links in a multi-layered structure, and the viewer 5 can connect to an advertisement delivery apparatus 1 that delivers advertising content 7 in a lower layer in which a genre, a category, a concept or the like is more narrowly focussed (targeted).

Management information 56 provided in the advertising component 54 contained in the advertising content 7 is provided with data in which the address of each WEB site 3a (i.e. site address of a trading or information site), and a management program for managing control data and audience ratings, or the like, is added. When the viewer 5 selects the address part, the data is sent as delivery history information.

Furthermore, in accordance with the above-mentioned conditions, advertising content 7 can be focussed on targets by classifying them into a predetermined genre, category and concept. As an example of classification by genres, advertising content 7 of a form in which multiple address parts are provided for accessing WEB sites 3a of car dealers or the like is possible. That is, classification by genres means classifying targets by associating them with each group of goods (goods include information and services, etc.) In addition, as an example of classification by categories, groups of advertisements displayed on public image viewers installed in convenience stores or trains are possible. That is, classification by categories means classifying targets by associating them with destination regions (place) of the delivery or time of delivery without specifically being particular about the group of goods, service content or the like.

In addition, as examples of classification by concept, “working women in their thirties”, “holidays of single men in their twenties” or the like is possible. That is, classification by concept means classifying users as targets by associating them with their points of view or ways of thinking regardless of group, field or the like of goods.

In any case, advertising content 7 in the advertisement delivery system of the present invention is generated or updated using means to be described below such that it is suitable for a specific market having clear target users. That is, advertising content 7 is generated by classifying an indistinct market by genre, category or concept and matching the classified markets with a way of thinking (decision) required by an advertiser 10. In other words, the address part for accessing the WEB site 3a of the advertiser 10 is set to provide optimum advertising contents 7 which match the classification of the WEB site 3a. Furthermore, if existing advertising content 7 that matches the way of thinking of an advertiser 10 who has made a request does not exist, new advertising content 7 is generated for the purpose of developing a new market.

Viewers 5 who receive advertisement delivery services utilizing the advertisement delivery system will now be described.

Viewer 5 refers to a service viewer who receives an advertisement delivery service of the advertisement delivery system by receiving delivery of the above-mentioned advertising content 7 utilizing the above-mentioned receiving device 4. That is, a viewer 5 in this context does not mean any user using an Internet device, but specifically means a viewer who actually receives delivery of advertising content 7. However, a user utilizing an Internet device can receive advertisement delivery utilizing the advertisement delivery system in future (or right away) even if the user does not receive the service up to some stage. Therefore, anybody using an Internet device can potentially be a viewer 5.

Furthermore, it has been explained that advertising content 7 to be generated/updated utilizing the advertisement delivery system is focussed on a predetermined target. A method of targeting is described with reference to FIG. 8.

In FIG. 8, reference numeral 9A denotes a target user group which is in the purchasing layer for goods from advertiser 10. That is, target user group 9A refers to the target of advertising content 7 having an advertisement of an advertiser 10 who requested the above-mentioned advertisement delivery company 6 to deliver the advertisement, and it does not matter whether a member in the target user group 9A is a viewer 5 who uses the above-mentioned receiving device 4 or not. In other words, a purchasing layer that does not have a receiving device 4 may be included in the target user group 9A, or a viewer 5 may exist in the target user group 9A. Furthermore, more specifically, a specific market that has the target user group 9A as a purchasing layer exists. Furthermore, the above-mentioned goods include services, information or the like provided by the advertiser 10.

In addition, reference numerals 9B and 9C are target user groups of advertising content 7 different from the advertising content 7 with target user group 9A as a target, i.e., other advertising content 7. Concerning the target user groups 9B and 9C, it also does not matter whether a member in the target user group 9A is a viewer 5 who uses the receiving device 4 or not. That is, a purchasing layer that does not have the receiving device 4 may be included in the target user groups 9B and 9C, or a viewer 5 may exist in the target user groups 9B and 9C. Furthermore, more specifically, a specific market that has the target user groups 9B and 9C as purchasing layers exists.

As shown in FIG. 8, the target user groups 9A, 9B and 9C partly overlap each other, and all three target user groups overlap in another part. In other words, some people (which simply means persons and does not mean the above-mentioned viewers 5) belong to only one of the target user groups 9A, 9B and 9C, some are arranged in a position where two target user groups 9A and 9B (or 9A and 9C or 9B and 9C) overlap, and some belong to all three target user groups 9A, 9B and 9C.

Each specific market having each of such target user groups 9A, 9B and 9C as purchasing layers exist in a wider market 9. The wider market 9, as described concerning each of the above-mentioned target user groups, indicates a place of business that continues as long as the (target user) human being exists regardless of whether or not it is connectable to a fast communication network 2 and can receive an advertisement delivery service utilizing the advertisement delivery system. Furthermore, at some point in time, a person who does not belong to any one of the target user groups of the advertising content 7 in a distributable state may join or leave any one of the target user groups due to change in time, change in state of mind or the like, or may join a target user group of new advertising content 7 that is generated thereafter.

Advertising content 7 to be generated/updated utilizing the advertisement delivery system is formed considering trend information of the above-mentioned wider market 9. This is because, naturally, there are a lot of people who belong to the purchasing layer of target goods who are target of an advertisement even if they are not Internet users, and these people are not unrelated to formation of a trend. That is, this embodiment is based on a recognition that market trend information of the wider market 9 should be considered when determining popularity of goods, market trends or the like regardless of whether or not a person is a viewer 5 who utilizes the Internet.

Furthermore, information service utilizing the advertisement delivery system will have a high utility value for a viewer 5 belonging to the target user group 9A by, for example, creating and delivering advertising content 7 for the viewer 5. However, this does not mean that only viewers 5 belonging to the target user group 9A can receive the information service, but all the viewers 5 can equally receive delivery.

Furthermore, as described above, advertising content 7 having one or more advertisements focussed on a specific target user group (e.g., a user group indicated by 9A) may only be simply stored in the advertisement delivery apparatus 1 and put in a state in which it is distributable to a viewer 5 after its generation or update, or may be configured such that the generation or update is notified specifically to a viewer 5 belonging to the target user group 9A by some method such as electronic mail.

The software parts used in the advertisement delivery system will now be described.

The advertisement delivery system configured as described above has the function of delivering advertising content 7 and the function of quantitatively evaluating advertising content 7 in the current state. Furthermore, the advertisement delivery system may be provided with the function of automatically creating advertising content 7, the function of delivering a special-purpose browser, or the like.

The function of performing advertising information service refers to the function of creating advertising content 7 having an advertisement configuration in which intentions of target user groups (specific market trend information) and trends (market trend information) held by advertisers 10, viewing histories of viewers 5 who actually browse advertising content 7, and the like are considered, and delivering appropriate advertising content 7, and indicates the content of the service provided by the advertisement delivery system and the advertising content 7.

Furthermore, the advertisement delivery system has a receiving function for receiving requests for delivery of advertising content 7. That is, this is a function of the advertisement delivery apparatus 1 acquiring delivery history when the advertisement delivery apparatus 1 receives delivery requests from the advertising content 7. In addition, the advertisement delivery system has the function of controlling delivery of advertising content 7. Moreover, the advertisement delivery system also has the function of delivering advertising content 7 to the receiving device of a viewer 5 or the function of delivering advertising content 7 on-line. In addition, the advertisement delivery system also has the function of receiving requests for connection to site addresses, the function of executing a connection request with respect to a WEB site 3a after obtaining connection information, and the function of transferring delivery history to the acquired information management section 13 (see FIG. 3) from the above-mentioned advertising content delivery section 15.

Advertising content software 7 has the basic function of making connection to linked destinations of WEB site 3a when a predetermined part of an advertisement in the advertising content 7 is selected, for example, a part comprised of videos, still images, titles or the like. Furthermore, this function is controlled via browsing software in the above-mentioned special-purpose browser if it is configured to deliver a special-purpose browser. In addition, software for reproducing advertising content 7 is provided with the function of reproducing videos, audio or the like to make them audible. Furthermore, the functions of the software of advertising content 7 can start up all the other operations such as recording viewing history without needing a special-purpose browser.

Moreover, software for reproducing advertising content 7 is provided with, for example, the function of making it selectable whether the updating of an advertisement browsed by a viewer 5 to the latest advertisement at any time is automatic or manually determined, the function of managing the selection function of site connection requests and their execution, the function of controlling delivery of audience rating management programs for managing audience rating and starting-up audience rating management programs, the function of causing the advertisement delivery apparatus 1 to send the managed viewing history information after the audience rating management program is started up.

Furthermore, an audience rating means information at the time when a viewer 5 browses the above-mentioned advertising content 7, and the data is a viewing history recorded when the viewer 5 browses the advertising content 7. The data configuration includes header information, viewing data and management related information. Header information means content of the entire acquisition condition parameters. Viewing data means data items designated by acquisition conditions to be described later, and means data in which even information (advertisement data management number, channel number or other information) on the time axis is acquired. In addition, management-related information means information managed by the above-mentioned advertisement delivery company 6.

A method of acquiring audience rating data (viewing history) is automatically executed by delivering an audience rating management program in advance to the receiving device 4 of a viewer 5 who is the target, setting acquisition condition parameters to the receiving device 4 having the audience rating management function, or embedding the audience rating management program in advertising content 7 in advance, as described above.

Starting/stopping audience rating acquisition processing and changing acquisition condition settings is automatically executed by the audience rating management program by changing the acquisition condition parameter settings upon new registration and updating of advertising content 7. In addition, changing the acquisition condition parameter settings may be performed by parameters in the receipt mail sent from the advertisement delivery apparatus 1 and received by the receiving device 4. Data acquired by the receiving device 4 is sent to the advertisement delivery apparatus 1. The acquisition condition parameters consist of identification information parameters, data acquisition start/stop parameter, acquisition condition parameters, and management-related information parameters.

The identification information parameters are identification information such as information on each advertisement target group, regional information or the like. The data acquisition start/stop parameter is data for controlling start and end of acquisition of audience rating data, and is for automatically performing acquisition of audience rating data on the designated date and time. Furthermore, the data acquisition start/stop parameter may be configured to start/stop acquisition on-line. In addition, the acquisition condition parameter is for designating sampling time of the advertising content 7 and content viewed by the viewer 5 using parameters. The parameters include, for example, a time axis parameter consisting of the interval in seconds, the interval in minutes or the like, parameters designating data items such as advertisement data management number, advertising channel 51 number or the like. In addition, the management-related information parameter is a parameter determining presence or absence of acquisition of information managed by the above-mentioned advertisement delivery company 6.

Detailed content of delivery history management will now be described. Management of delivery history includes management of information managed by the above-mentioned advertisement delivery company 6 and management of information from accessed WEB sites 3a. That is, management of delivery history means managing history such as delivered content, the number of deliveries or the like for advertising content 7 obtained by a viewer 5 accessing the advertisement delivery apparatus 1 (see FIG. 1) to be a control server having advertising content 7, and managing history information of viewers 5 accessing the WEB site 3a as information from the WEB site 3a side. Furthermore, delivery history recorded by the advertising content delivery section 15 of the above-mentioned advertisement delivery apparatus 1 excludes information from the WEB site 3a side, and the history information recorded on the WEB site 3a side is sent to the advertisement delivery apparatus 1 from the WEB site 3a side.

Furthermore, if the WEB site 3a is a trading site, an access history for the trading site becomes trading history information upon generation of an operation in the site. In addition, if the WEB site 3a is an information site, acts in the information site such as the number of accesses simply become history information. Furthermore, on-line trading refers to a trading method performed in electronic trading. In addition, trading history information is information managed on the trading site side and includes customer information, purchasing content, the number of purchases, the number of estimate requests, goods (services) that are the object of estimates or the like. Delivery history information refers to information on how many delivery requests are made to the advertisement delivery apparatus 1 from a viewer 5, which is acquired by the unit of advertising content 7 (or by WEB site 3a).

The flow of each type of information and mutual relationship mechanism in the above-mentioned advertisement delivery system will now be described with reference to FIG. 9. Furthermore, in the following description, the same reference numerals as used in the above descriptions are used for representing parts corresponding to the elements used in the above descriptions. In addition, FIG. 9 shows an operating method or act itself, and the part performing the act is described by associating it with the advertisement delivery apparatus 1 described in FIG. 3.

Reference numeral 1 in FIG. 9 denotes the above-mentioned advertisement delivery apparatus 1. Furthermore, a business model using the advertisement delivery system is operated by managing and operating the advertisement delivery apparatus 1. An organization that handles advertising information using the advertisement delivery system to establish a business is referred to as an advertisement delivery company 6 in this description.

Reference numeral 7 (shown in the advertising content delivery section 15) in FIG. 9 denotes advertising content 7 arranged in the advertising content delivery section 15 in the advertisement delivery apparatus 1 that is the apparatus for realizing the advertisement delivery system. As describe above, in this embodiment, the unit of advertising information provided as a service by the advertisement delivery company 6 is the advertising content 7. The advertising content 7 includes a basic advertising content 53, advertising content selection 52, advertising channel 51 or the like if it is formed in a multi-layered structure (see FIGS. 6 and 7). In addition, as described above, the advertising content selection 52 makes it possible to make a selection from among multiple basic advertising content items 53.

In this embodiment, the advertisement delivery system is used to deliver basic advertising content 53 or advertising content selections 52 (see FIGS. 6 and 7). Furthermore, naturally, the advertisement delivery system may be configured such that the advertisement delivery company 6 delivers an advertising channel 51 (see FIGS. 6 and 7) to be arranged in an upper layer above the advertising content selection 52. Furthermore, quite the contrary, the advertisement delivery system may be configured such that the advertisement delivery company 6 specially delivers a single basic advertising content item 53 only.

If advertising content 7 has multiple advertising content selections 52, advertising content selection 52 selected by viewer 5 from the advertising content selection layer 52a is first delivered, and then the selected basic advertising content 53 in the advertising content selection 52 is delivered. Furthermore, depending on the size of advertising content selection 52, it is possible to deliver basic advertising content 53 at the same time as the advertising content selection 52.

Advertising content 7 is configured to have a clear target user group 9A and to be suitable for a market with the target user group 9A as an object. That is, it is the main object of the business provided by the advertisement delivery company 6 to divide an indistinct market into groups and deliver advertising content 7 associated with the target user group 9A to be a target of the market.

Reference numeral 74 indicated in the wider market 9 of FIG. 9 denotes marketing. The marketing indicated here has three meanings (elements) as described below. The first element is to survey information of the target user group 9A as market trends using objective means and without using the function of the advertisement delivery apparatus 1 (the function of acquiring viewing history information, delivery history information, trading history information or the like). The second element is to survey advertisements, information, goods or the like that match the target user group 9A. That is, this means specifying an advertiser 10 and an advertising agency 10a. The third element is market surveys for targeting objects for which advertiser 10 and advertising agency 10a wish to place advertisements and do market surveys to assist product development and decide market focus (product concept).

The wider market 9 shown in FIG. 9 refers to a place of business that continues as long as the (target user) human being exists regardless of whether or not it makes a connection to (participate in) the fast communication network 2. That is, the wider market 9 includes existing potential users who do not make a connection to (participate in) the fast communication network 2. Thus, the target user group 9A also includes potential users.

Reference numerals 5 and 5′ shown in the wider market 9 denote a viewer who receives delivery of advertising content 7 from the advertisement delivery apparatus 1 operated by the advertisement delivery company 6. Furthermore, the viewer indicated by the reference numeral 5 is a viewer belonging to the target user group 9A, and the viewer indicated by the reference numeral 5′ indicates other viewers. In addition, although, for convenience of description, those viewers belonging to the target group 9A and other viewers are indicated by the reference numerals 5 and 5′ respectively in FIG. 9, these are simply indicated as the viewer 5 in other drawings.

In addition, reference numeral 77 in FIG. 9 (the line drawn from receiving devices 4 of the viewers 5 and 5′ in the wider market 9 who have received delivery of advertising content 7 to the advertisement delivery apparatus 1, respectively) denotes a request for delivery of advertising content 7. The delivery request 77 refers to an act performed by the viewers 5 and 5′ with respect to the advertisement delivery apparatus 1 for receiving delivery of advertising content 7. A connection to the advertising content delivery section 15 for delivering advertising content 7 includes, as described above (see FIG. 7), an indirect connection method performed from the advertising channel 51 or other basic advertising content 53 or advertising content selection 52, and a direct connection method that is performed when a connection destination has already been connected and is saved in the receiving devices 4 of viewers 5 and 5′, or performed by inputting a connection destination in a connection device.

Reference numeral 78 in FIG. 9 (the line drawn from the advertisement delivery apparatus 1 to the receiving devices 4 of viewers 5 and 5′ in the wider market 9 who have received delivery of advertising content 7, respectively) denotes delivery of advertising content 7. That is, delivery 78 refers to the act of delivering advertising content 7 to viewers 5 and 5′ upon receiving a delivery request 77. In addition, acquisition 87a of delivery history information is performed by the advertising content delivery section 15 recording the first delivery history at this time and then sending the first delivery history to the acquired information management section 13 from the advertising content delivery section 15. Furthermore, the first delivery history and its delivery history information are described later.

Reference numeral 79 in FIG. 9 (the line drawn from the receiving devices 4 of viewers 5 and 5′ in the wider market 9 who have received delivery of advertising content 7 from the advertisement delivery apparatus 1) denotes a request for connection from the site address embedded in the advertising component 54 of the delivered advertising content 7. The advertising content 7 has one or more advertising components 54 which are minimum-sized advertisement units (see FIGS. 5, 6 and 7), and its time duration may be an arbitrary length. The delivered advertising content 7 may be browsed in different ways depending on the receiving devices 4 of the viewers 5 and 5′, but contains a site address (address part) and event (program) for requesting a connection to the site address; these are necessary for realizing a site connection after browsing the advertisement data 55 contained in the advertising component 54. In this case, one site address or multiple site addresses may be included depending on the configuration (program) of the address component 54.

Furthermore, the viewers 5 and 5′ can make a connection to a WEB site 3a directly rather than via the advertising content delivery section 15 of the advertisement delivery apparatus 1. In addition, viewers 5 and 5′ can also make a connection setting via the advertising content delivery section 15 invalid. If viewers 5 and 5′ make a setting invalid, viewers 5 and 5′ can make a connection to a WEB site 3a indicated by the site address of the advertising component 54.

Reference numeral 80 in FIG. 9 (the line drawn from the advertisement delivery apparatus 1 to the WEB server 3 for sites) denotes the act of the advertisement delivery apparatus 1 making a connection to a WEB site 3a after obtaining a request 79 for connection to a site address. That is, when receiving the request 79 for connection to a site address in the advertising component 54, the advertisement delivery apparatus 1 makes a request for connection to the WEB site 3a using the site address as the object of the connection request. In addition, the advertising content delivery section 15 records the second delivery history at this time, and performs acquisition 87b of delivery history information by thereafter sending the second delivery history to the acquired information management section 13 from the advertising content delivery section 15.

Reference numeral 83 in FIG. 9 that denotes the line drawn from the WEB server for sites 3 to the receiving device 4 of the viewer 5 in the target user group 9A (although there should originally be a line drawn from the WEB server for sites 3 to the receiving device 4 of the viewer 5′ in the wider market 9 who has received delivery of advertising content 7 in FIG. 9, it is omitted for simplicity of the drawing) indicates that a WEB site 3a is connected to the receiving devices 4 of the viewers 5 and 5′ via the advertising content delivery section 15 (see reference numerals 79 and 80) for delivering advertising content 7 to the viewers 5 and 5′. Furthermore, the receiving devices 4 can be directly connected to the WEB site 3a. From the viewpoint of the viewers 5 and 5′, when the receiving devices 4 are connected to the WEB site 3a via the advertising content delivery section 15, the viewers 5 and 5′ select an advertisement in the delivered advertising content 7 (more strictly, this means activating a connection requesting event in the advertising component 54), and makes a connection to the WEB site 3a that has a link relationship.

Reference numeral 84 connecting the receiving device 4 of the viewer 5 in the target user group 9A and the WEB server for sites 3 (although there should originally be a line connecting the receiving device 4 of the viewer 5′ in the wider market 9 who has received delivery of advertising content 7 and the WEB server for sites 3 in FIG. 9, it is omitted for simplicity of the drawing) denotes trading/communication between the viewers 5 and 5′ and the WEB site 3a. A trading act indicates a bi-directional act that the viewer 5 and 5′ performs mainly with a trading site. Communication indicates a bi-directional act when the receiving device 4 is connected to a site (information site) other than the trading site. There are two methods of connection, as described above.

Reference numeral 85 in FIG. 9 (the line drawn from the WEB server for sites 3 to the acquired information management section 13) indicates acquisition of information such as trading history information. The acquisition is one of the functions for quantitatively determining that the advertisement delivery system is effectively delivering advertising content 7. That is, trading history information and (including acts in a trading site other than the trading act) and connection information of the trading site is acquired from the trading site, and data such as the number of times of utilization of the trading site is acquired from an information site. In this way, basic information for calculating contribution made by the viewers 5 and 5′ who have received delivery of advertising content 7 that is linked to the WEB site 3a and effects of the advertisement are acquired. Furthermore, information in a site such as trading history is recorded on the WEB site 3a side as described above, and is sent to the advertisement delivery apparatus 1 from the WEB site 3a.

Reference numeral 86 in FIG. 9 (the line drawn from the viewers 5 and 5′ in the wider market 9 who have received delivery of advertising content 7 to the acquired information management section 13) denotes acquisition of viewing history information. This is one of the functions for quantitatively assuring that the advertisement delivery system is effectively delivering advertising content 7 like the acquisition of trading history information 85. The acquisition of viewing history information 86 refers to acquiring as audience rating data information on what kind of advertising content 7 the viewers 5 and 5′ have received and what kind of advertisement the viewers 5 and 5′ have viewed. That this is effective means that it is possible to compare and verify relationships and association between a market such as the target user group 9A and the actual viewer 5 and 5′.

Furthermore, points of comparison and verification are as follows: firstly, verifying accuracy and appropriateness of targeting of target; secondly, verifying a market itself such as the target user group 9A taken as one market; and thirdly, verifying the difference between the targeting of targets and the intention of the advertiser 10 (the product concept and marketing of an advertiser). Furthermore, the viewing history information is recorded on the receiving device 4 sides of the viewers 5 and 5′ as described above, and is sent to the advertisement delivery apparatus 1 from the receiving devices 4.

Reference numerals 87a and 87b denoting lines directed from the advertising content delivery section 15 to the acquired information management section 13 indicate acquisition of the first and the second delivery history information, respectively. This is one of the functions for quantitatively determining that the advertisement delivery system is effectively delivering advertising content 7 like the acquisition of trading history information 85 and the acquisition of viewing history information 86.

The first delivery history information indicates information about how many delivery requests, acquired in units of advertising content 7, have been made to the advertisement delivery apparatus 1 from the viewers 5 and 5′. The second delivery history information indicates, as history information, how many connections to a WEB site 3a the viewers 5 and 5′ who have received delivery of advertising content 7 have made via the advertisement delivery apparatus 1 for delivering advertising content 7 in units of WEB sites 3a.

The point at which the first delivery history is recorded is the time when the advertisement delivery apparatus 1 receives a delivery request 77 for advertising content 7. The point at which the second delivery history is recorded is the time when the advertisement delivery apparatus 1 receives a connection request 79 for site address in the advertising component 54. Furthermore, in FIG. 9, acquisition of the first delivery history information and acquisition of the second delivery history information are denoted by reference numerals 87a and 87b, respectively.

Reference numeral 88 denotes the line directed from an advertiser 10 or an advertising agency 10a to the advertisement delivery apparatus 1 indicates an advertisement request to an advertisement delivery company 6 that manages the advertisement delivery apparatus 1 from an advertiser 10 or advertising agency 10a. Advertisements that are not limited in terms of time frame become possible, so freer expression in advertisements is available to the advertiser 10 or advertising agency 10a by making advertisement requests 88 utilizing the advertisement delivery system. Moreover, since advertising content 7, which is the advertising information, is classified into one of: genre, category or concept, an advertiser 10 or the like can effectively target advertisements at markets such as intended target user groups 9A.

The line indicated by the advertisement request 88 also refers to an access to the advertisement delivery company 6 when the advertisement delivery system is selected as one of the publicizing methods considered by the advertiser 10 or the advertising agency 10a. Furthermore, reference numeral 88 not only simply represents a request but also includes evaluation or the like of advertising content 7 in which the advertiser's own advertisement is displayed.

Reference numeral 89 shown in the advertisement generation element management section 11 indicates an advertisement delivery charge. For example, if the advertisement delivery company 6 utilizes a unique fast Ethernet network provided by a broadcasting company 8 (see FIG. 4), its facility usage charge is incurred. In addition, if a broadcasting company 8 establishes an advertising channel 51 (see FIGS. 6 and 7) and an advertisement delivery company 6 utilizes it as a delivery destination for advertising content 7, establishment costs and maintenance costs are considered to be incurred. The costs are incurred separately from remuneration for delivery services of advertising content 7 provided by the advertisement delivery company 6. In this way, the advertisement delivery charge 89 refers to a charge not included in delivery service costs of advertising content 7 in the advertisement delivery company 6.

Reference numeral 90 shown in the advertisement generation element management section 11 of FIG. 9 indicates a list of advertisement charges. The advertisement charge list 90 indicates charges for inserting an advertisement in advertising content 7 provided by the advertisement delivery company 6 as a service. The price setting is determined and maintained to be a charge system corresponding to the effect of investment (current price evaluation amount) considering superiority (degree of superiority) or the like of the effect of investment deriving from quantitative numerical information of the advertising content 7 indicated by market recognition of advertising content 7, the size of the market such as the target user group 9A held by the advertising content 7, degree of coincidence between the target user group 9A and advertiser 10, and the above-mentioned acquisition of trading history information 85, acquisition of viewing history information, and acquisitions of two kinds of delivery history information 87a and 87b.

Reference numeral 91 shown below the advertisement charge list 90 denotes selection by the advertiser 10. The selection 91 by the advertiser 10 is strictly an act performed by the advertiser 10 or the advertising agency 10a. Selection 91 by the advertiser 10 refers to the act of examining advertising charges and determining if the charge 7 for inserting advertisements in advertising content as shown in the advertisement charge list 90 is cost effective for the advertiser 10 in terms of advertising effectiveness.

Reference numeral 92 in FIG. 9 (the line drawn from the advertisement generation element management section 11 to the advertisement data management section 12) denotes preparation for inserting an advertisement. Depending on contents of the contract between the advertisement delivery company 6 and the advertiser 10 or advertising agency 10a, the form of preparation is considerably different depending on the way the advertisement data 55 (see FIG. 5) is to be incorporated into the advertising content 7. For example, if the advertiser 10 or the advertising agency 10a already has the advertising data 55, the advertisement data 55 is registered in the database of the advertisement data management section 12.

On the other hand, to add newly-generated advertisement data 55 to the advertising content 7, the new advertisement data 55 is generated and registered in the advertisement data management section 12. Preparation for adding an advertisement 92 refers to this above-mentioned act.

Various elements for creating advertising content 7 are shown in the advertisement generation element management section 11. The advertising content 7 depends solely on how the target user group is narrowed down. The commodity value (added value) of the advertising content 7 as advertising information is increased by associating acquired information (see reference numeral 94) such as the viewing history or the like of the advertising content 7 to be acquired and managed and a market trend 95 and a trend 96 to be taken in the advertisement generation element management section 11 with the focussed target user group.

This targeting operation may be clear concerning a market existing in a fixed frame such as the target user group 9A. However, if a new market is generated or new targeting is performed, classification by concepts or the like applied to users showing interest in the advertisement delivery system for the first time can be insufficiently defined, or can be useless or meaningless. In other words, if classification by concepts or the like is clear, the corresponding targeting operation can be regarded as complete. Furthermore, by adding an automatic advertisement generation function to the advertisement delivery system, definition of classification or the like may be realized, and generation of a market or incorporation of new users may be performed utilizing this function.

Arranged in the acquired information management section 13 and denoted by reference numeral 94 is acquisition management of a viewing history, two kinds of delivery history and a trading history of advertising content 7. The advertising content 7 is intended to be delivered more accurately and with more suitable content to a market such as the target user group 9A that is focussed by classifying by concepts or the like.

The concept of advertising content 7 itself is an important element in the business format provided by the advertisement delivery company 6. Supporting the concept of advertising content 7 as a system is the acquisition management 94 of two kinds of delivery history, a viewing history and a trading history. The acquisition management 94 of viewing history and the like is a function required by the advertisement delivery system to effectively deliver the advertising content 7. The advertisement delivery apparatus 1 manages the integrated version of the above-mentioned first and second delivery history as integrated total delivery history information, and manages the acquired and integrated version of the viewing history as audience rating information. In addition, the advertisement delivery apparatus 1 manages the acquired and integrated version of a trading history as integrated trading history information.

Furthermore, although all of the above-mentioned history information is acquired and managed in this embodiment, any one, two or three items of history information may be acquired and managed, based on which advertising content 7 may be generated or updated. In addition, after acquiring and managing all pieces of the history information, an arbitrary piece of information may be extracted and utilized as basic information for creating advertising content 7.

The market trend 95 refers to information acquired by performing the above-mentioned marketing 74, that is, information concerning a market obtained by performing the marketing 74 with respect to the target user group 9A without using the function (the function of acquiring information such as a viewing history) provided by the advertisement delivery system. Furthermore, the object of surveying market trends 95 without using the function provided by the advertisement delivery system in this way is as described below.

First, not all the viewers 5 belonging to the target user group 9A receive delivery of advertising content 7 generated by the advertisement delivery system. In other words, not all the people belonging to the target user group 9A have the receiving device 4. In addition, not all the people belonging to the target user group 9A and having the receiving device 4 receive delivery of advertising content 7. From such a situation, those who have received the advertising content 7 among the people belonging to the target user group 9A can be regarded as a part of the people. In the advertisement delivery system, it is not considered to be so effective to perform marketing targeting a part of the target user group 9A.

Secondly, in some cases, delivery of advertising content 7 is delivered to a viewer 5′ not belonging to the target user group 9A. The advertising content 7 is not likely to be so interesting to the viewer 5′. Thus, a browsing operation is completely different compared with viewer 5 belonging to the target user group 9A. That is, it is anticipated that viewer 5′ is not interested in the advertising content 7 and immediately stops browsing. It is considered to be less meaningful to count such viewing history or the like of such a person as a market trend.

That is, information indicated by viewing history or delivery history is not always equivalent to market trend information concerning a market targeting the target user group 9A. In order to correctly evaluate the advertising content 7 by the target user group 9A, the above-mentioned market trends 95 are surveyed and results of the survey are used as elements for creating advertising content 7. Furthermore, viewing history, delivery history or trading history are effective in quantitatively measuring the current state and can be indispensable information in performing a market analysis (generation or incorporation of new markets), but are not useful information for reading and predicting the future. In order to have advertising content 7 in which the intentions of advertisers 10 are easily reflected, the advertisement delivery company 6 operating the advertisement delivery system is required to perform marketing from the standpoint of the advertiser 10.

Unlike market trends 95 obtained from marketing 74, the trend 96 refers to the future direction, to policy or direction of the industry, or characteristics or features held by a generation. In addition, since culture (characteristics or features) of nations and laws or regulations adopted by a country or an economic zone also affect the market in a broad sense (in temporal space), these are included in trends 96 in the advertisement delivery system.

The advertisement data processing section 12 refers to a database managing advertisement data 55 as described before. Furthermore, in this embodiment, the advertisement data management section 12 is provided in the advertisement delivery apparatus 1 (see FIG. 3) that is managed and operated by the advertisement delivery company 6. However, the advertisement data management section 12 may be configured as an apparatus independent from the advertisement delivery apparatus 1. In addition, the advertisement data management section 12 may be directly managed and operated by the advertisement delivery company 6, or may be managed and operated by an advertisement data warehouse (an independent company that manages data such as advertisement data) authorized by the advertisement delivery company 6. Moreover, the advertisement data management section 12 may be managed and operated by the broadcasting company 8.

Reference numeral 98 indicating the line directed from the advertisement data section 12 to the advertising content generation section 14 denotes incorporation of advertisement data 55 from the advertisement data management section 12 to advertising content 7. That is, the incorporation refers to the act of taking into the advertising content generation section 14 advertisement data 55 that is planned to be merged into the advertising content 7 in accordance with the targeting of the target user group 9A targeted by the advertising content 7.

Reference numeral 99 indicating the line drawn from the advertisement generation element management section 11 to the advertising content generation section 14 denotes development of new advertising content 7. It is important for development of new advertising content 7 to derive targets of new advertising content 7 whose development is planned. As a development form of a target of the advertising content 7, there are cases in which advertising content 7 is developed based on markets that already exist, such as target user groups 9A, and cases in which new classification is performed based on predetermined genres, categories or concepts and advertising content 7 is developed according to the classification.

In addition, as described above, an automatic advertisement generation function can be added to the advertisement delivery system. If this function is added, by creating new markets using this function or by performing automatic targeting to decide a target user group, advertising content 7 that matches the target user group can be developed. Moreover, by automatically deciding target user group from market trends 95 and trends 96 or information of existing advertising content 7, advertising content 7 that matches the target user group may be developed.

In addition, advertising content 7 derived from an existing advertising content 7 may be developed utilizing the automatic advertisement generation function. Moreover, as an automatic advertisement generation function by which the intentions of the advertiser 10 can be reflected, advertising content 7 to which an intention of an advertiser 10 can be reflected may be developed. For example, advertising content 7 may be developed which is configured such that one entire advertising content 7 is composed of one company, or one advertising content 7 is formed by backup of an industry or an organization.

Reference numeral 100 indicating the line drawn from the acquired information management section 13 to the advertising content generation section 14 denotes utilizing acquired information such as a viewing history in order to sophisticate or update existing advertising content 7. The above-mentioned target user group 9A changes by progress of a temporal space indicated by a trend 96. Thus, advertising content 7 must collect information such as viewing history of the advertising content 7 and information concerning market trends 95 and trends 96, and maintain commodity value (added value) by incorporating such information as updating elements of the advertising content 7. Update of advertising content 7 refers to these operations. That is, more specifically, replacement of advertisement data 55 or replacement of advertising components 54 is performed based on information acquired by the acquired information management section 13.

The advertising content generation section 14 receives necessary advertisement data 55 from among the various kinds of advertisement data 55 registered in the advertisement data management section 12, and performs an operation of inputting the advertisement data 55 in advertising components 54 in which information such as site address of a WEB site 3a is incorporated. That is, the advertising content generation section 14 creates advertising components 54. Furthermore, the advertising content generation section 14 may develop advertising content 7 itself anew and place an advertisement. In such a case, the advertising content generation section 14 needs to perform targeting of new target user group and development 99 of advertising content 7 for the target user group in addition to incorporating operation of advertisement data 55 in advertising components 54.

Reference numeral 101 in FIG. 9 (the line directed from the advertising content generation section 14 to the advertising content delivery section 15) denotes an act of registering advertising content 7 in the advertising content delivery section 15. The act of registering advertising content 7 in the advertising content delivery section 15 differs depending on characteristics of advertising content 7. That is, the act means new registration in the case of new advertising content 7, and means update (replacement) in the case of existing advertising content 7. However, its management (decision on updating) is left to the advertisement delivery company 6 that determines operation of the advertisement delivery system.

Reference numeral 102 in FIG. 9 (an arrow shown by a dotted line directed from the advertising content generation section 14 or the advertising content delivery section 15 to the advertisement generation element management section 11) denotes new registration and update or deletion of a catalogue of advertising content 7. An advertiser 10 or an advertising agency 10a refers to a catalogue of advertising content 7 in which an advertisement charge list 90 and users to be targets are written in selection 91 by an advertiser 10. Thus, a catalogue of advertising content 7 indicates service content itself of the advertisement delivery company 6. New registration, update and deletion of a catalogue of advertising content 7 refers to the act of reflecting new advertising content 7 and the existing advertising content 7 in the catalogue.

Operations of the advertisement delivery system are hereinafter described with reference to FIG. 9 that shows the flow of each piece of information and the mechanism of mutual interrelationship of elements.

When an advertisement delivery company 6 is requested by an advertiser 10 to manage an advertisement such as its own advertisement, the advertisement delivery company 6 creates advertising content 7 that is provided with advertising component 54 having advertisement data 55 of the advertiser 10. Furthermore, each advertising component 54 is provided with an address part (site address) that is linked to a WEB site 3a for the own advertisements of the advertiser 10. Therefore, when a viewer 5 receives delivery of generated advertising content 7, the viewer 5 can browse advertisements in the advertising content 7, and can make a connection to the WEB site 3a of the advertiser 10 by selecting a predetermined position of the advertisement, and so forth.

Furthermore, the advertising content 7 is generated, considering market trend information of specific markets set for each user group that is a purchasing (utilizing) layer of goods sold by the advertiser 10 (including information, services or the like the advertiser 10 deals in), acquired information such as viewing history or the like of viewers 5 and 5′, and the like, to match such information. Thus, when an advertisement of the advertiser 10 is merged into the advertising content 7, the possibility of effectively making browsing of its advertisement by a viewer 5 belonging to a target user group 9A intended by the advertiser 10 or the other viewers 5′, and invitation of the viewers into a WEB site 3a for its advertisement after the browsing.

Furthermore, at the point (time) of generation, if there is no existing advertising content 7 focussed on a target intended by the advertiser 10, the advertisement delivery company 6 creates advertising content 7 that is focussed on a new target. Then, the advertisement delivery company 6 inserts an advertisement of the advertiser 10 in the new advertising content 7. In this way, the advertiser 10 can effectively advertise and publicize its goods (including information, services or the like) to the target user group 9A which is in the purchasing layer of the goods. The viewers 5 and 5′ can receive delivery of new advertising content 7 and make a connection to the WEB site 3a for advertisement of the goods of the advertiser 10 via the advertisement delivery apparatus 1.

Furthermore, if an advertiser 10 does not have a WEB site 3a for advertisement of its goods or the like, viewers 5 and 5′ create new WEB site 3a that the viewers can browse via a fast communication network 2. An object of the present invention is to guide viewers 5 and 5′ to a WEB site 3a for advertisement of goods of an advertiser 10 via the advertisement delivery apparatus 1.

An advertiser 10 may create a WEB site 3a by itself, or may request an advertising agency 10a to request a generation company 10b (see FIG. 4) to create a WEB site 3a. Moreover, instead of requesting an advertisement delivery company 6 only to manage a WEB site 3a, an advertiser 10 may also request the advertisement delivery company 6 to create a WEB site 3a. The advertisement delivery company 6 may, upon receiving the request, then request a generation company 10b to create a WEB site 3a of the advertiser 10.

Moreover, an advertiser 10 may request an advertising agency 10a to create a WEB site 3a and the advertising agency 10a may further request a generation company 10b to create the WEB site 3a, and the advertiser 10 may request the advertisement delivery company 6 to manage the generated WEB site 3a.

Furthermore, viewers 5 and 5′, recognizing a target group the viewers 5 and 5′ belong to, can browse preferred advertisements simply by browsing advertising content 7 that is focussed on the target group, and can also make a connection to desired WEB sites 3a from the advertisement. Furthermore, if the advertisement 7 is linked to other advertising content 7 and the advertising content 7 is composed in a multi-layered structure, the viewers 5 and 5′ can easily reach an object advertising content 7, and can also easily make selection on which target group the viewers 5 and 5′ narrow down themselves to.

When advertising content 7 is sent to a broadcasting station 8 from an advertisement delivery company 6 via a fast communication network 2 or by other means, the broadcasting company 8 can perform broadcast or data communication in which the advertising content 7 is incorporated. In this way, viewers 5 and 5′ can receive advertising content 7 from a fast communication network 2 directly by an Internet television viewer 44, a special-purpose device 45 or a personal computer 46 and browse the advertising content 7.

In this case, what kinds of advertising content 7 the viewers 5 and 5′ have browsed can also be recorded as a viewing history. In addition, delivery history at the time of delivering advertising content 7 or delivery history at the time of connecting to the WEB site 3a via the advertisement delivery apparatus 1 after receiving delivery of advertising content 7 is also recorded. As described above, the advertisement delivery company 6 creates or updates advertising content 7 for new broadcast or data transmission referring to each piece of the history information.

In addition, the viewers 5 and 5′ can also receive delivery of the above-mentioned advertising content 7 by a predetermined device through a predetermined broadcasting company 8 via a fast communication network 2. That is, viewers 5 and 5′ can receive a digital signal sent from a digital broadcasting company 61 via a communication satellite 64 via a television provided with a tuner for receiving digital broadcasts 41 and browse the advertising content 7, can receive a digital signal sent from a cellular phone company 62 by next-generation cellular phone 42 and browse the advertising content 7, or can receive a signal sent via a private line 65 from a cable television company 63—using a television for receiving cable television broadcasts 43—and browse the advertising content 7.

Then, procedures for a viewer 5 to receive delivery of advertising content 7 by making a connection to an advertisement delivery apparatus 1 using a receiving device 4 the viewer 5 has and further make a connection to a WEB site 3a via the advertisement delivery apparatus 1, and operation of the advertisement delivery system in the procedures is described below with reference to FIGS. 10 and 11. Furthermore, reference numerals affixed to elements are the same as those used in the description of the above-mentioned configurations.

First, utilizing a receiving device 4 (step S1), a viewer 5 sends a request for delivery of advertising content 7 via a fast communication network 2. An advertisement delivery apparatus 1 records the first delivery history at the time of receiving the request (step S2).

Furthermore, if the advertising content 7 is provided with an address part showing a link relationship with other advertising content 7 as described above and the advertising content 7 are configured in a multi-layered structure, the viewer 5 requests delivery of a program selection screen 60 at this point. Thereafter, the viewer 5 may narrow down the advertising content 7 to an advertising channel 51, advertising content selection 52, basic advertising content 53, or the like. In addition, the viewer 5 may request targeting as basic advertising content 53 after requesting delivery of an advertising content selection 52, or may request delivery of basic advertising content 53 directly.

Then, when a request for delivery of advertising information is sent to the above-mentioned delivery apparatus 1 by any of these methods, the advertising content 7 saved in the advertisement delivery apparatus 1 is delivered to the receiving device 4 of the viewer 5 (step S3). Thus, the viewer 5 can receive delivery of advertising content 7 and browse it. Furthermore, as described above, the receiving device 4 of the viewer 5 records a viewing history of the advertising content 7 of the viewer 5 by some means (step S4).

It is assumed that the viewer 5 selects a predetermined part having a link relationship in a viewed advertisement while the viewer 5 is browsing the advertising content 7. This act corresponds to selection of the address part (site address) provided in the advertising component 54 of the advertising content 7 (step S5). If the address selected by the viewer 5 is the site address of a WEB site 3a (condition J1), an event program in the advertising component 54 starts up, and makes a request for connection to the WEB site 3a (step S6). Thus, the receiving device 4 of the viewer 5 is connected to the WEB site 3a (step S7).

On the other hand, if the address selected in step S5 is an address that is linked to other advertising content 7 (condition J2), a request for delivery of other advertising content 7 arranged in the selected address is sent from the advertising component 54. That is, the processing returns to step S1. Furthermore, the flow of operations after the processing returns to step S1 is the same as the flow described above.

In addition, when a site address is selected, if the address does not exist or the address does not indicate any site (a site address sometimes does not exist) (condition J3), the receiving device 4 maintains a state of connection with the advertising content 7 (step S21).

In addition, as shown in FIG. 11, when the receiving device 4 is connected to the WEB site 3a in step S7, the advertisement delivery apparatus 1 records a second delivery history (step S11). Furthermore, if the connected WEB site 3a is a trading site (Yes in step S12), the processing proceeds to step S13. On the other hand, if the connected WEB site 3a is a site other than a trading site, that is, an information site (No in step S12), acquisition activity of history information concerning the viewer 5 once ends at this point (step S15).

If the connected WEB site 3a is a trading site (Yes in step S12) and the viewer 5 takes the action of requesting an estimate or trading in the connected trading site, that is, the viewer 5 utilizes the trading site (Yes in step S13), a trading history corresponding to the action is recorded on the trading site side (step S14), and thereafter sent to the advertisement delivery apparatus 1 from the trading site by some method.

Thus, the advertisement delivery apparatus 1 receives the trading history sent from the trading site and performs acquisition management of the trading history information in the above-mentioned acquired information management section 13. The acquisition activity of the history information concerning the viewer 5 once ends at this point (step S15).

Furthermore, in the advertisement delivery system of the above-mentioned first embodiment, although it is described that a more substantial advertising information delivery service can be offered by adding an automatic advertisement generation function, a retrieving function or the like, configuration of an apparatus having these functions is not specifically described. Therefore, configuration of an apparatus other than the advertisement delivery apparatus 1 for operating the above-mentioned advertisement delivery system is described as the second through tenth embodiments of the present invention. Furthermore, descriptions of functions, operations or the like of parts having the same functions as those of the first embodiment are omitted or simplified, and same reference numerals are used for parts identical with or similar to those of the first embodiment.

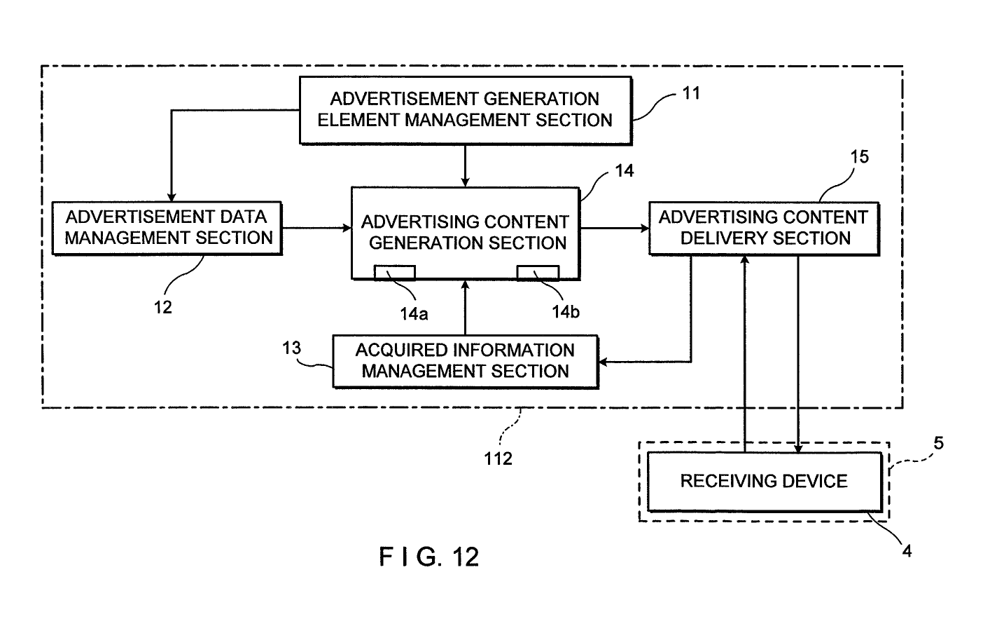

An advertisement delivery apparatus 112 in the second embodiment of the present invention is described with reference to FIG. 12.

As shown in FIG. 12, the advertisement delivery apparatus 112 is provided with an advertisement generation element management section 11 for managing various elements for targeting advertising content to a predetermined target, an advertisement data management section 12 for accumulating and managing various kinds of advertisement data 55 forming advertising content 7, a acquired information management section 13 for acquiring viewing history, delivery history and trading history and managing the acquired information, advertising content generation section 14 for selecting optimum advertisement data 55 based on the various generation elements and various kinds of acquired information to create the advertising content 7, and advertising content delivery section 15 that can deliver the generated advertising content 7 to a receiving device 4 of a viewer 5 via a fast communication network 2 and record a delivery history at that point, and at the same time, make requests for connections to WEB sites 3a.

Furthermore, the various kinds of elements for targeting advertising content to a predetermined target consist of market trends 95 (market trend information) of specific markets to which user groups which are targets of the advertising content 7, trend information (a trend 96) of wider markets 9 to which the user group belongs, decision (selection 91 of an advertiser) of an advertiser 10 to be a client, or the like as in the above-mentioned first embodiment.

In this second embodiment, the above-mentioned advertising content generation section 14 is provided with first analyzing means 14a and second analyzing means 14b for analyzing the market trend information (market trends 95) of the specific market to which the user group to be a target of the advertising content 7 and trend information (the trends 96) of the wider market 9 to which the user group belongs, respectively, among the various elements acquired by the acquired information management section 13. Furthermore, each of the analyzing means 14a and 14b may be located anywhere in the advertisement delivery apparatus 112. For example, the acquired information management section 13 may be configured to be provided with both the analyzing means 14a and 14b.

Furthermore, although main functions of the advertisement delivery apparatus 112 in the above-mentioned second embodiment are similar to the above-mentioned first embodiment, the second embodiment is specifically characterized by being integrally provided with the analyzing means 14a and 14b for analyzing the above-mentioned various elements in the advertisement delivery apparatus 112.

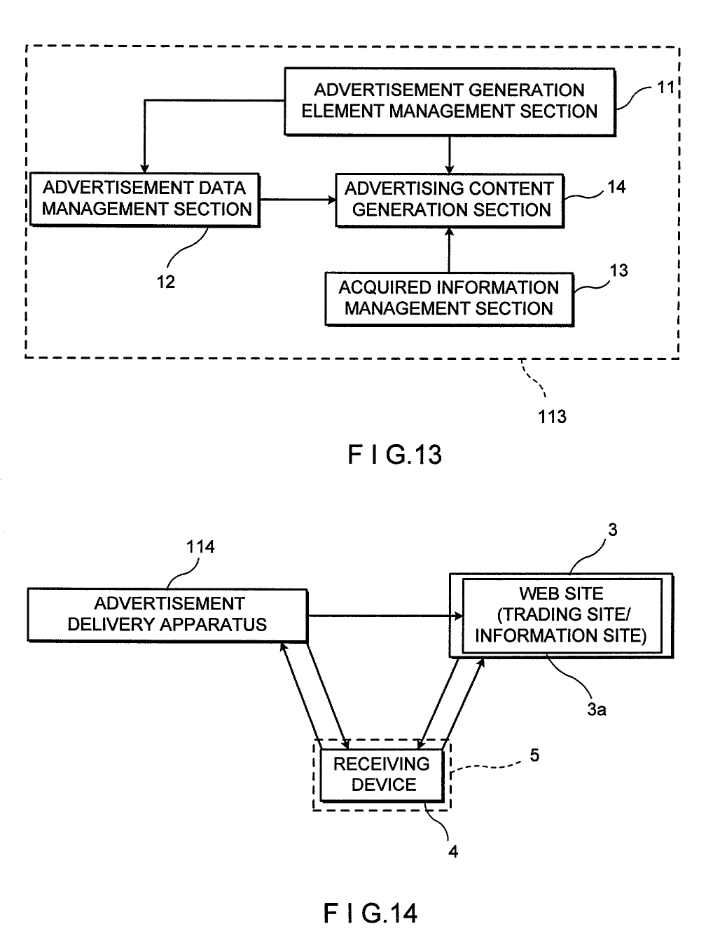

An advertisement delivery apparatus 113 in the third embodiment of the present invention is described with reference to FIG. 13.

As shown in FIG. 13, the advertisement delivery apparatus 113 has a configuration that is similar to the advertisement delivery apparatus 1 of the first embodiment except that the advertising content delivery section 15 is not included. That is, the advertisement delivery apparatus 113 is provided with an advertisement generation element management section 11 for managing various elements for targeting advertising content to a predetermined target, an advertisement data management section 12 for accumulating and managing various kinds of advertisement data 55 forming advertising content 7, an acquired information management section 13 for acquiring viewing history, delivery history and trading history and managing the acquired information, and advertising content generation section 14 for selecting optimum advertisement data 55 based on the various generation elements and various kinds of acquired information to create the advertising content 7.

Furthermore, although the advertisement delivery apparatus 113 in the third embodiment does not have the advertising content delivery section 15, an apparatus corresponding to the advertising content delivery section that is provided separately may be connected to the advertisement delivery apparatus 113 via fast communication network 2 or directly not via the fast communication network 2. When the advertisement delivery apparatus 113 is configured in this way, it becomes possible to send advertising content 7, that is finally generated in the advertising content generation section 14, to the separate delivery apparatus and deliver it to the viewer 5 from the delivery apparatus. Thus, it becomes possible to operate the advertisement delivery system shown in the above-mentioned first embodiment.

An advertisement delivery apparatus 114 in the fourth embodiment of the present invention is described with reference to FIG. 14.

As shown in FIG. 14, the advertisement delivery apparatus 114 is an apparatus that has only the function of the advertising content delivery section 15 in the above-mentioned first and second embodiments. That is, the advertisement delivery apparatus 114 can receive advertising content 7 that is generated by another apparatus, which performs the function of creating advertising content 7 and the function corresponding to the acquired information management section 13, and stores the advertising content 7 inside it. In addition, the advertisement delivery apparatus 114 can deliver the advertising content 7, that is stored inside it, to a receiving device 4 of a viewer 5, and can make a request for connection to a WEB site (a trading site or an information site) stored in the WEB server 3 for sites.

Therefore, when the viewer 5 receives delivery of advertising content 7 of the advertisement delivery apparatus 114 using the receiving device 4, selects advertisement data 55 at a predetermined position in the delivered advertising content 7, and so forth, a request for connection to a WEB site 3a indicated in the site address provided in the selected part is sent to the WEB site 3a from the advertising content 7 via the advertisement delivery apparatus 114. Thus, the receiving device 4 can be connected to the WEB site 3a in the WEB server 3 for sites. Furthermore, naturally, the receiving device 4 can also make a request for connection to the WEB site 3a directly not via the advertisement delivery apparatus 114, thereby making a connection to the WEB site 3a.

Furthermore, although the advertisement delivery apparatus 114 of the fourth embodiment does not have the function of creating advertising content 7 as described above, for example, if the advertisement delivery apparatus 114 is connected to the advertisement delivery apparatus 113 of the above-mentioned third embodiment, the advertisement delivery apparatus 114 can cause the advertisement delivery apparatus 113 to send advertising content 7 generated in the advertisement delivery apparatus 113 to the advertisement delivery apparatus 114, and stores it inside. Thus, the advertisement delivery apparatus 114 can operate the advertisement delivery system described in the above-mentioned first embodiment.

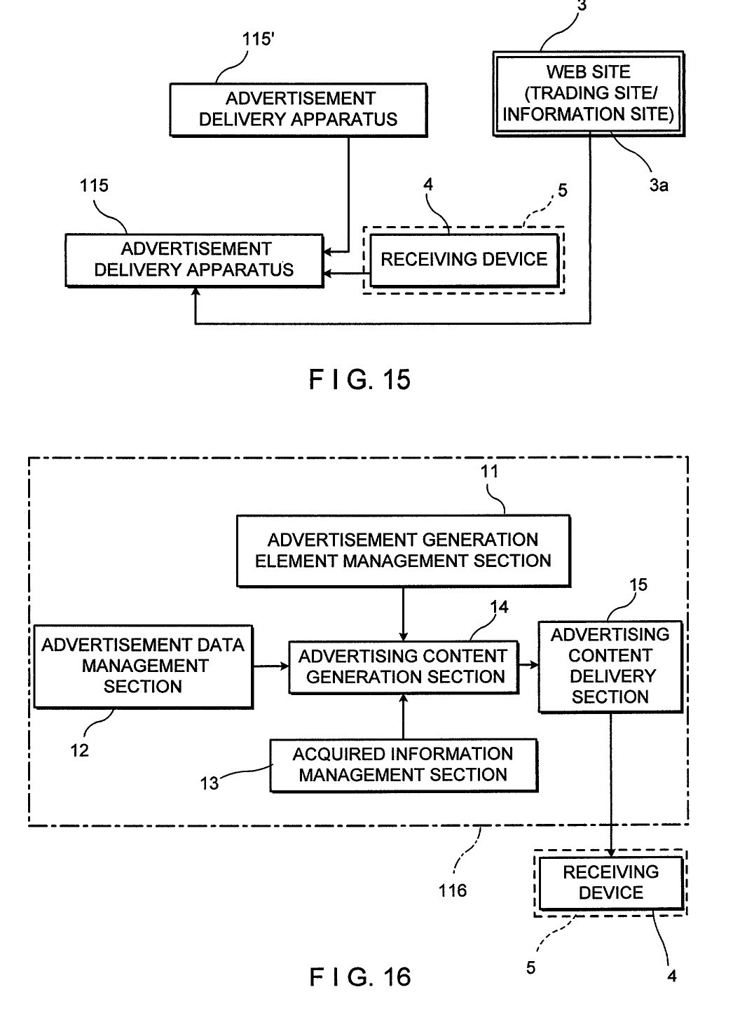

An advertisement delivery apparatus 115 in the fifth embodiment of the present invention are described with reference to FIG. 15.

As shown in FIG. 15, the advertisement delivery apparatus 15 only has the function of the acquired information management section 13 in the above-mentioned first and second embodiments. That is, the advertisement delivery apparatus 115 has the function of causing the receiving device 4 of the viewer 5 to send viewing history to the advertisement delivery apparatus 115 and acquiring the viewing history. In addition, the advertisement delivery apparatus 115 has the function of causing the advertisement delivery apparatus 115′ provided with a delivery function and a delivery control function to send at least one (or both) of delivery history at the time of delivering advertising content 7 to the viewer 5 from the advertisement delivery apparatus 115′ and delivery history at the time of when the viewer makes a connection to a WEB site 3a via the advertisement delivery apparatus 115′ that delivers the advertising content 7 to the advertisement delivery apparatus 115, and acquiring the delivery history.

Moreover, the advertisement delivery apparatus 115 has the function of causing a trading site to send a trading history of the viewer 5 to be utilization information of the trading site to the advertisement delivery apparatus 115 and acquiring the trading history. This function is carried out if the advertising content 7 is delivered to the viewer 5 from the above-mentioned delivery apparatus 115′ and the viewer 5 makes a connection to the WEB site 3a in the WEB server 3 for sites from the delivered advertising content 7 via the advertisement delivery apparatus 115′, or if the viewer 5 having made a connection to the WEB site 3a via the advertisement delivery apparatus 115′ for at least one or more times makes, for example, a connection to the WEB site 3a directly not via the advertisement delivery apparatus 115′ in second and subsequent connections and the WEB site 3a is a trading site. That is, the advertisement delivery apparatus 115 is provided with the function of acquiring viewing history, delivery history and trading history that are described in the above-mentioned first embodiment.

Furthermore, although the advertisement delivery apparatus 115 of the fifth embodiment does not have the function of creating advertising content 7 as described above, the function of delivering generated advertising content 7, or the like, the advertisement delivery apparatus 115 may exist as, for example, an external apparatus of the advertisement delivery apparatuses 1 and 112 in the first and the second embodiments having these functions.

Furthermore, although each of the advertisement delivery apparatuses 1 and 112 of the first and the second embodiments is configured to have a part corresponding to the function held by the advertisement delivery apparatus 115 of the fifth embodiment, the advertisement delivery apparatuses 1 and 112 may have a configuration in which the part is deleted and replaced by the advertisement delivery apparatus 115 of the fifth embodiment, or the part is supplemented by the advertisement delivery apparatus 115 of the fifth embodiment. In any case, with such a configuration, the advertisement delivery system described in the first embodiment can be operated.

An advertisement delivery apparatus 116 of the sixth embodiment of the present invention will now be described with reference to FIG. 16.

As shown in FIG. 16, the advertisement delivery apparatus 116 is provided with an advertisement generation element management section 11 for managing various elements for targeting advertising content to predetermined targets, an advertisement data management section 12 for accumulating and managing various kinds of advertisement data 55 forming advertising content 7, an acquired information management section 13 for acquiring viewing history, delivery history and trading history and managing the acquired information, advertising content generation section 14 for selecting optimum advertisement data 55 based on the various generation elements and various kinds of acquired information to create the advertising content 7, and an advertising content delivery section 15 that can deliver the generated advertising content 7 to a receiving device 4 of a viewer 5 via fast communication network 2 and record delivery history at that point, and at the same time, make requests for connection to WEB sites 3a.

Furthermore, the difference between the advertisement delivery apparatus 116 in the sixth embodiment and the advertisement delivery apparatuses of the first and the second embodiments is that the advertising content generation section 14 in the advertisement delivery apparatus 115 has the function of automatically creating advertising content 7.

This automatic generation function is the function of automatically creating new advertising content 7 when new market is generated or when advertising content is focussed/targeted. That is, it is the function of automatically creating advertising content 7 by combining existing advertising components 54 based on new concepts or the like when new advertising content 7 is developed.

This function sets generation parameters, and advertising content is automatically generated by a program in the advertisement delivery apparatus 116. By this automatic generation function, for example, advertising content 7 containing only advertising components 54 with a high audience rating can be generated, or advertising content 7 assuming a genre or a viewer age group can be generated. Furthermore, the automatic generation function of the sixth embodiment has the same operation as those when the advertisement delivery apparatus is provided with an automatic generation function that is as described in the above-mentioned first embodiment.

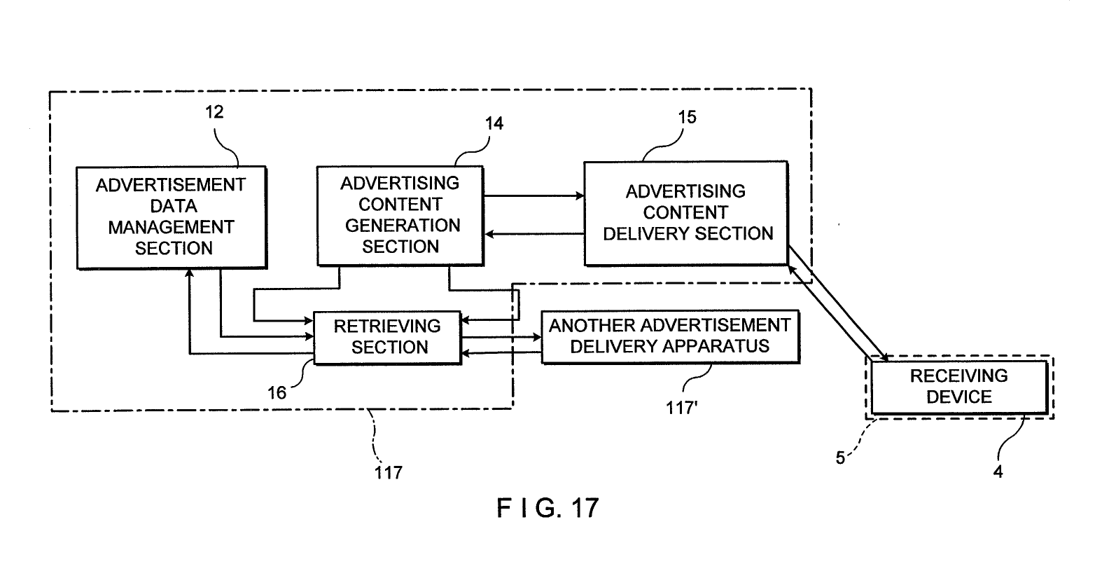

The advertisement delivery apparatus 117 of the seventh embodiment of the present invention is described with reference to FIG. 17.

Furthermore, the advertisement delivery apparatus 117 of the seventh embodiment to be described below is provided with a retrieving function that cannot be realized by the apparatus configurations of the above-mentioned first through sixth embodiments. In addition, the retrieving function is the function included in the automatic generation function described in the sixth embodiment.

With the advertisement delivery apparatus 117 of the seventh embodiment having the retrieving function in the automatic generation function, a viewer 5 not only can find a target to which the viewer 5 belongs to or an advertisement from among multiple advertising content 7 simply arranged in a multi-layered structure but also can retrieve a target or an advertisement by independently inputting keywords or the like. That is, the advertisement delivery apparatus 117 of the seventh embodiment has the function of extracting advertisement data 55 that matches the retrieval conditions to create new advertising content 7 by the viewer 5 designating a predetermined classification or the like or inputting keywords or the like in the advertisement delivery apparatus 117.

As shown in FIG. 17, the advertisement delivery apparatus 117 is provided with an advertisement data management section 12 for accumulating and managing various kinds of advertisement data 55 forming advertising content 7, advertising content generation section 14 for selecting optimum advertisement data 55 based on the various generation elements and various kinds of acquired information to create the advertising content 7, advertising content delivery section 15 that stores advertising content 7 inside and delivers the advertising content 7 according to requests from viewers 5, and at the same time, records the delivery history upon delivery, and a retrieving section 16 for retrieving and extracting advertisement data 55 from the advertisement data management section 12 and another advertisement delivery apparatus 117′ connected to the advertisement delivery apparatus 117.

When the viewer 5 inputs keywords or the like of a classification or a word that the viewer wishes to retrieve using a receiving device 4 of the viewer 5, the advertisement delivery apparatus 117 having the above-mentioned configuration extracts advertisement data 55 associated with the advertising content 7, advertising content generation section 14 for selecting optimum advertisement data 55 based on the various generation elements and various kinds of acquired information to create the advertising content 7, advertising content delivery section 15 that stores advertising content 7 inside and delivers the advertising content 7 according to requests from viewers 5, and at the same time, records delivery history upon delivery, and a retrieving section 16 for retrieving and extracting advertisement data 55 from the advertisement data management section 12 and another advertisement delivery apparatus 118′ connected to the advertisement delivery apparatus 118.

The advertisement delivery apparatus 118 having the above-mentioned configuration is characterized in that the advertisement delivery apparatus 118 automatically starts retrieval when the data volume of acquired information such as viewing histories sent to the advertisement delivery apparatus 118 exceeds a fixed amount or periodically, at predetermined times.

When the above-mentioned retrieval conditions are met, the advertisement delivery apparatus 118 extracts advertisement data 55 associated with the retrieval conditions from the advertisement data management section 12 and another advertisement delivery apparatus 118′ to create advertising content 7.

That is, the above-mentioned retrieving section 16 starts retrieval operations based on the retrieval conditions. Furthermore, various kinds of advertisement data 55 such as advertising (images) and audio are arranged by predetermined classification and saved in the advertisement data management section 12. The retrieving section 16 extracts the advertisement data 55 associated with retrieval conditions from another advertisement delivery apparatus 118′ (which may be managed and operated by a company other than the advertisement delivery company 6 that manages and operates the advertisement delivery apparatus 118) connected to the advertisement delivery apparatus 118 via the fast communication network 2 and from the advertisement data management section 12, and sends the extracted advertisement data 55 to the advertising content generation section 14.

The advertising content generation section 14 incorporates the advertisement data 55 acquired from the advertisement data management section 12 and another advertisement delivery apparatus 118′ in one advertising content 7 and arranges the advertisement data 55 in the retrieval conditions from the advertisement data management section 12 and another advertisement delivery apparatus 117′ to create advertising content 7. That is, contents of inputted keywords or the like are inputted in the advertising content generation section 14 via the advertising content delivery section 15, based on which the advertising content generation section 14 instructs the retrieving section 16 to start retrieval of the advertisement data associated with the inputted retrieval conditions.

The retrieving section 16 starts retrieval operations based on the instruction from the above-mentioned advertising content generation section 14. Furthermore, as in the above-mentioned first and second embodiments, various kinds of advertisement data 55 such as advertising (images) and audio are arranged by a predetermined classification and saved in the advertisement data management section 12. The retrieving section 16 extracts the advertisement data 55 associated with retrieval conditions set by the viewer 5 from another advertisement delivery apparatus 117′ (which may be managed and operated by a company other than the advertisement delivery company 6 that manages and operates the advertisement delivery apparatus 117) connected to the advertisement delivery apparatus 117 via the fast communication network 2 and from the advertisement data management section 12, and sends the extracted advertisement data 55 to the advertising content generation section 14.

The advertising content generation section 14 incorporates the advertisement data 55 acquired from the advertisement data management section 12 and another advertisement delivery apparatus 117′ in one advertising content 7 and arranges the advertisement data 55 in the advertising content delivery section 15. Thus, the advertising content delivery section 15 delivers the advertising content 7 to the receiving device 4 of the viewer 5.

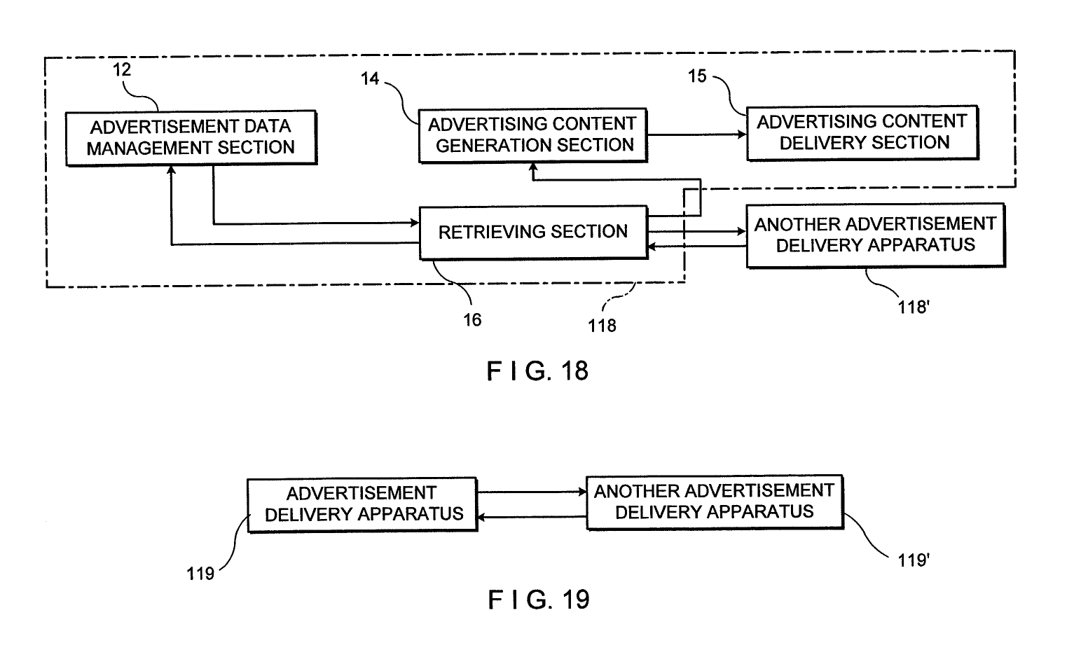

The advertisement delivery apparatus 118 of the eighth embodiment of the present invention will now be described with reference to FIG. 18. Furthermore, although the advertisement delivery apparatus 118 of the eighth embodiment to be described below is substantially similar to the above-mentioned seventh embodiment, the difference is that the advertisement delivery apparatus 118 automatically starts retrieval operations regardless of acts of the viewer 5 such as inputting.

As shown in FIG. 18, the advertisement delivery apparatus 118 is provided with an advertisement data management section 12 for accumulating and managing various kinds of advertisement data 55 forming advertising content delivery section 15. Thus, the advertising content delivery section 15 delivers the advertising content 7 to the receiving device 4 of the viewer 5.

The advertisement delivery apparatus 119 in the ninth embodiment of the present invention will now be described with reference to FIG. 19.

The advertisement delivery apparatus 119 is an apparatus only having the function of the retrieving section 16 in the above-mentioned seventh and eighth embodiments. That is, the advertisement delivery apparatus 119 is an apparatus that can only retrieve advertisement data 55 for creating advertising content 7, and only extracts and retrieves advertisement data 55 from another advertisement delivery apparatus 119′ connected to the advertisement delivery apparatus 119. Furthermore, another advertisement delivery apparatus 119′ may be a simple database in which advertisement data 55 is accumulated.

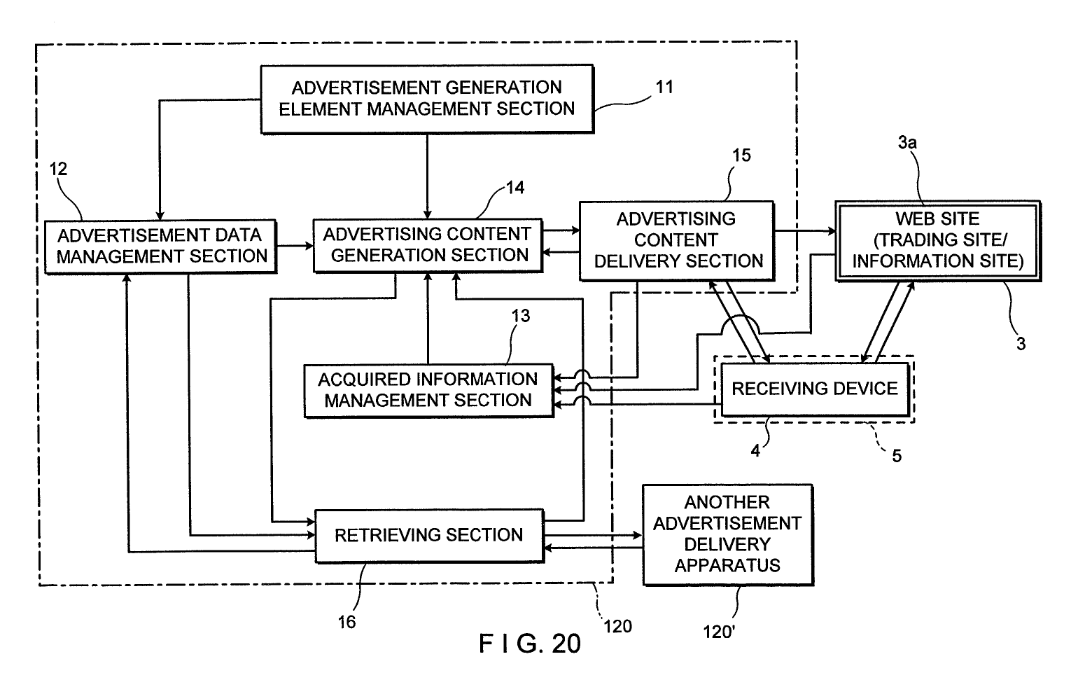

Lastly, an advertisement delivery apparatus 120 in the tenth embodiment of the present invention are described with reference to FIG. 20.

As shown in FIG. 20, the advertisement delivery apparatus 120 is provided with an advertisement generation element management section 11 for managing various elements for targeting advertising content to a predetermined target, an advertisement data management section 12 for accumulating and managing various kinds of advertisement data 55 forming advertising content 7, a acquired information management section 13 for acquiring viewing history, delivery history and trading history and managing the acquired information, advertising content generation section 14 for selecting optimum advertisement data 55 based on the various generation elements and various kinds of acquired information to create the advertising content 7, advertising content delivery section 15 that can deliver the generated advertising content 7 to a receiving device 4 of a viewer 5 via fast communication network 2 and record delivery history at that point, and at the same time, make requests for connection to WEB sites 3a, and a retrieving section 16 for retrieving and extracting advertisement data 55 from the advertisement data management section 12 and another advertisement delivery apparatus 120′ connected to the advertisement delivery apparatus 120. That is, the advertisement delivery apparatus 120 is an apparatus provided with all the functions of apparatuses described in the above-mentioned first through ninth embodiments.

Furthermore, although each of the above-mentioned embodiments shows an example of a preferred embodiment of the present invention, the present invention is not limited to the embodiments, but may be modified in various ways and implemented without departing from the spirit and the scope of the present invention. For example, each of the above-mentioned embodiments was described on the condition that the advertisement delivery company 6 manages and operates an advertisement delivery apparatus for delivering or otherwise sending advertising content 7. However, this is only for an illustration purpose, and this may be changed to a form in which the advertisement delivery company 6 does not exist and only the broadcasting company 8 or other advertisement related companies exist.

In addition, in the above-mentioned description of each embodiment, a delivery history at the time when a viewer 5 received delivery of advertising content 7 and a delivery history at the time when the viewer 5 makes a connection to a WEB site 3a via the advertisement delivery apparatus 1 for delivering advertising content 7 are recorded in the advertisement delivery apparatus 1. However, the advertisement delivery apparatus 1 may be programmed such that the advertising content 7 records the delivery histories. In addition, in the above-mentioned description, each of the embodiments is configured such that, when a viewer 5 who has received delivery of advertising content 7 for at least one or more times makes a connection to a trading site and takes some action in the trading site, the trading site records a trading history of the viewer 5 and sends the history to the advertisement delivery apparatus 1. However, the advertisement delivery apparatus 1 may be programmed such that advertising content 7 records the trading history.

In addition, in the above-mentioned description, it is described that hardware called an advertisement delivery apparatus always exists in each of the embodiments. However, the present invention is not limited to the hardware. That is, the present invention may be software provided with each function of the advertisement delivery apparatus in each of the above-mentioned embodiment, or may be a recording medium in which a program for executing such various functions is recorded.

As described, using the advertisement delivery system, the advertisement delivery apparatus, and the advertisement delivery method of the present invention, since advertising content that has one or more advertisements focussed on a predetermined target in advance and is provided with an address part that is linked to a predetermined WEB site or other advertising content is arranged on a fast communication network, a viewer can easily reach a desired WEB site or the like via an advertisement delivery apparatus that delivers the advertising content. In addition, if the viewer receives delivery of advertising content that matches a target group to which the viewer belongs, browsing the delivered advertising content becomes interesting, and a WEB site or the like linked from the advertising content becomes interesting for the viewer.

Therefore, from the viewpoint of an advertiser, a target user who belongs to a purchasing layer of its products can be effectively guided to advertising content in which its advertisement is inserted, WEB sites for its advertisements, or the like as a viewer. Furthermore, it becomes possible to create special new markets that look promising in future one after another, and to deliver advertising content to new users belonging to the special market without delay by considering acquired information such as a viewing history or the like of a target user and a trend of a current market in targeting a target.

Thus, it is seen that an advertisement delivery system, advertising content and advertisement delivery apparatus, and an advertisement delivery method are provided. One skilled in the art will appreciate that the present invention can be practiced by other than the preferred embodiments which are presented for the purposes of illustration and not of limitation, and the present invention is limited only by the claims which follow.

Figures

FIG. 2

3a WEB SITE

7 ADVERTISING CONTENT

OTHER ADVERTISING CONTENT

FIG. 3

INTENTION OF AN ADVERTISER

MARKET TREND INFORMATION

TREND INFORMATION

DELIVERY HISTORY

TRADING HISTORY

VIEWING HISTORY

4 RECEIVING DEVICE

11 ADVERTISEMENT GENERATION ELEMENT MANAGEMENT SECTION

12 ADVERTISEMENT DATA MANAGEMENT SECTION

13 ACQUIRED INFORMATION MANAGEMENT SECTION

14 ADVERTISING CONTENT GENERATION SECTION

15 ADVERTISING CONTENT DELIVERY SECTION

FIG. 4

REQUEST

REQUEST FOR GENERATION

5 ADVERTISING CONTENT OPERATION MANAGEMENT CONSULTANT

AUDIENCE RATING MANAGEMENT

8 BROADCASTING COMPANY

10 ADVERTISER

10a ADVERTISING AGENCY

10b GENERATION COMPANY

42 NEXT GENERATION CELLULAR PHONE

45 SPECIAL-PURPOSE DEVICE

61 DIGITAL BROADCASTING COMPANY

62 CELLULAR PHONE COMPANY

63 CABLE TELEVISION COMPANY

64 SATELLITE

65 PRIVATE LINE

FIG. 5

3a WEB SITE (TRADING/INFORMATION SITE)

5 VIEWER

BROWSING SOFTWARE

55 ADVERTISEMENT DATA

56 MANAGEMENT INFORMATION

57 ADVERTISING COMPONENT CONTROL SECTION

59 ADVERTISING CONTENT CONTROL SECTION

FIG. 6

51a ADVERTISING INFORMATION CHANNEL LAYER

52a ADVERTISING CONTENT SELECTION LAYER

53a BASIC ADVERTISING CONTENT LAYER

ADVERTISING INFORMATION

ADVERTISING COMPONENT

ADVERTISEMENT DATA

FIG. 7

4 RECEIVING DEVICE

51a ADVERTISING INFORMATION CHANNEL LAYER

52a ADVERTISING CONTENT SELECTION LAYER

53a BASIC ADVERTISING CONTENT LAYER

ADVERTISING COMPONENT

FIG. 8

TARGET USER

FIG. 9

3a WEB SITE (TRADING SITE/INFORMATION SITE)

9A TARGET USER

10, 10a ADVERTISER/ADVERTISING AGENCY

14 DEVELOPMENT OF NEW ADVERTISING CONTENT

DEVELOPMENT OF AN EXISTING ADVERTISING CONTENT

89 ADVERTISEMENT DELIVERY CHARGE

90 ADVERTISEMENT CHARGE LIST

91 SELECTION OF AN ADVERTISER

94 AUDIENCE RATING/DELIVERY HISTORY/TRADING HISTORY

95 MARKET TREND

96 TREND

CAR

BANK

FOOD

OTHERS

FIG. 10

S1 REQUEST DELIVERY OF ADVERTISING CONTENT

S2 RECORD A FIRST DELIVERY HISTORY

S3 DELIVER THE ADVERTISING CONTENT TO A VIEWER

S4 RECORD A VIEWING HISTORY

S5 SELECT A PREDETERMINED SITE ADDRESS IN THE ADVERTISING CONTENT

J1 IN CASE AN ADDRESS IS A SITE ADDRESS OF A WEB SITE

J2 IN CASE AN ADDRESS INDICATES ANOTHER ADVERTISING CONTENT

J3 IN CASE NO ADDRESS EXISTS OR AN ADDRESS DOES NOT INDICATE ANYTHING

S6 REQUEST A CONNECTION TO THE WEB SITE

S7 CONNECT TO THE WEB SITE

S21 CONTINUE CONNECTION WITH THE ADVERTISING CONTENT

RETURN TO S1

CONTINUE TO S11 OF FIG. 11

FIG. 11

S7 OF FIG. 10

S11 RECORD A SECOND DELIVERY HISTORY

+S12 IS THE WEB SITE A TRADING SITE?

S13 IS THE TRADING SITE UTILIZED?

S14 RECORD A TRADING HISTORY

S15 FINISH AACQUISITION ACTIVITY OF VARIOUS HISTORIES

FIG. 12

4 RECEIVING DEVICE

11 ADVERTISEMENT GENERATION ELEMENT MANAGEMENT SECTION

12 ADVERTISEMENT DATA MANAGEMENT SECTION

13 ACQUIRED INFORMATION MANAGEMENT SECTION

14 ADVERTISING CONTENT GENERATION SECTION

15 ADVERTISING CONTENT DELIVERY SECTION

FIG. 13

11 ADVERTISEMENT GENERATION ELEMENT MANAGEMENT SECTION

12 ADVERTISEMENT DATA MANAGEMENT SECTION

13 ACQUIRED INFORMATION MANAGEMENT SECTION

14 ADVERTISING CONTENT GENERATION SECTION

FIG. 14

3a WEB SITE (TRADING SITE/INFORMATION SITE)

4 RECEIVING DEVICE

114 ADVERTISEMENT DELIVERY APPARATUS

FIG. 15

3a WEB SITE (TRADING SITE/INFORMATION SITE)

4 RECEIVING DEVICE

115 ADVERTISEMENT DELIVERY APPARATUS

115′ ADVERTISEMENT DELIVERY APPARATUS

FIG. 16

4 RECEIVING DEVICE

11 ADVERTISEMENT GENERATION ELEMENT MANAGEMENT SECTION

12 ADVERTISEMENT DATA MANAGEMENT SECTION

13 ACQUIRED INFORMATION MANAGEMENT SECTION

14 ADVERTISING CONTENT GENERATION SECTION

15 ADVERTISING CONTENT DELIVERY SECTION

FIG. 17

4 RECEIVING DEVICE

12 ADVERTISEMENT DATA MANAGEMENT SECTION

14 ADVERTISING CONTENT GENERATION SECTION

15 ADVERTISING CONTENT DELIVERY SECTION

16 RETRIEVING SECTION

117′ ANOTHER ADVERTISEMENT DELIVERY APPARATUS

FIG. 18

12 ADVERTISEMENT DATA MANAGEMENT SECTION

13 ADVERTISING CONTENT GENERATION SECTION

15 ADVERTISING CONTENT DELIVERY SECTION

16 RETRIEVING SECTION

118′ ANOTHER ADVERTISEMENT DELIVERY APPARATUS

FIG. 19

119 ADVERTISEMENT DELIVERY APPARATUS

119′ ANOTHER ADVERTISEMENT DELIVERY APPARATUS

FIG. 20

3a WEB SITE (TRADING SITE/INFORMATION SITE)

4 RECEIVING DEVICE

11 ADVERTISEMENT GENERATION ELEMENT MANAGEMENT SECTION

12 ADVERTISEMENT DATA MANAGEMENT SECTION

13 ACQUIRED INFORMATION MANAGEMENT SECTION

14 ADVERTISING CONTENT GENERATION SECTION

15 ADVERTISING CONTENT DELIVERY SECTION

16 RETRIEVING SECTION

120′ ANOTHER ADVERTISEMENT DELIVERY APPARATUS

What is claimed is:

1. An advertisement delivery system for delivering an advertisement to a viewer via a fast communication network, comprising:
advertising content, in a form for transmission on said fast communication network, having one or more advertisements that are focussed on a predetermined target in advance, said advertising having an address part indicating a link relationship with a WEB site relating to said advertisements;
an advertisement delivery apparatus for delivering said advertising content being arranged on said fast communication network; and
said advertising content being delivered by said delivery apparatus to the viewer in response to a request of the viewer.

2. An advertisement delivery system for delivering an advertisement to a viewer via a fast communication network, comprising:
advertising content, in a form for transmission on said fast communication network, having one or more advertisements that are focussed on a predetermined target in advance, said advertising content having an address part indicating a link relationship with other advertising content relating to said advertisements;
an advertisement delivery apparatus for delivering said advertising content being arranged on said fast communication network; and
said advertising content being delivered by said delivery apparatus to the viewer in response to a request of the viewer.

3. An advertisement delivery system for delivering an advertisement to a viewer via a fast communication network, comprising:
advertising content, in a form for transmission on said fast communication network, having one or more advertising components in which management information is added to advertisement data and each advertisement is focussed on a predetermined target by at least one of: a predetermined genre, a predetermined category and a predetermined concept and being configured with an arbitrary time, said advertising content being delivered to the viewer by said network.

4. An advertisement delivery system for delivering an advertisement to a viewer via a fast communication network, comprising:
advertising content, in a form for transmission on said fast communication network, having one or more advertising components in which management information is added to advertisement data, said advertising content being delivered to the viewer.

5. The advertisement delivery system according to claim 3, wherein said advertising component has at least one or more address parts each indicating a link relationship with a WEB site relating to said advertisements or other advertising content.

6. The advertising delivery system according to claim 4, wherein said advertising component has at least one or more address parts each indicating a link relationship with a WEB site relating to said advertisements or other advertising content.

7. The advertising delivery system according to claim 3, wherein one advertisement composed of said plurality of advertising components is provided in said advertising content.

8. The advertising delivery system according to claim 4, wherein one advertisement composed of said plurality of advertising components is provided in said advertising content.

9. An advertisement delivery system for delivering an advertisement to a viewer via a fast communication network, comprising:
advertising content automatic generation portion for automatically creating new advertising content, in a form for transmission on said fast communication network, based on at least one of: multiple viewing histories, delivery histories and trading histories of the viewer being provided.

10. An advertisement delivery system for delivering an advertisement to a viewer via a fast communication network, comprising:
advertising content, in a form for transmission on said fast communication network, having one or more advertisements that are focussed on a predetermined target in advance;
an advertisement delivery apparatus for delivering said advertising content;
a receiving device with which the user can browse said advertising content; and
a WEB site that is linked to said focussed advertisements.

11. An advertisement delivery system for delivering an advertisement to a viewer via a fast communication network, comprising:
advertising content, in a form for transmission on said fast communication network, having one or more advertisements that are focussed on a predetermined target in advance; and
a receiving device with which the user can browse said advertising content, wherein when the viewer receives delivery of said advertising content from said receiving device and performs an operation for browsing said advertising content, the browsing operation is recorded as a viewing history.

12. An advertisement delivery system for delivering an advertisement to a viewer via a fast communication network, comprising:
advertising content, in a form for transmission on said fast communication network, having one or more advertisements that are focussed on a predetermined target in advance; and
a receiving device with which the user can browse said advertising content, wherein when the viewer receives delivery of said advertising content from said receiving device and continues an operation for browsing said advertising content for a predetermined length of time or more, the browsing operation is recorded as a viewing history.

13. An advertisement delivery system according to claim 11, wherein said viewing history is sent from said receiving device to an advertisement delivery apparatus for delivering said advertising content.

14. An advertisement delivery system according to claim 12, wherein said viewing history is sent from said receiving device to an advertisement delivery apparatus for delivering said advertising content.

15. An advertisement delivery system according to claim 13, wherein said viewing history is recorded, and a viewing history management program for sending said viewing history, upon delivery of said advertising content, to said advertisement delivery apparatus is incorporated in said receiving device of the viewer.

16. An advertisement delivery system according to claim 14, wherein said viewing history is recorded, and a viewing history management program for sending said viewing history, upon delivery of said advertising content, to said advertisement delivery apparatus is incorporated in said receiving device of the viewer.

17. An advertisement delivery system for delivering an advertisement to a viewer via a fast communication network, comprising:
advertising content, in a form for transmission on said fast communication network, having one or more advertisements that are focussed on a predetermined target in advance and having an address part that is linked to a WEB site relating to said advertisements;
an advertisement delivery apparatus for delivering said advertising content; and
a receiving device with which the viewer can browse said advertising content;
wherein said advertisement delivery apparatus records as a delivery history at least one of a delivery history at the time when said advertising content is delivered to said receiving device and a delivery history of information including a connection to said WEB site when said receiving device receives delivery of said advertising content and the viewer may perform an operation for browsing said advertising content and make a connection to said WEB site via said advertisement delivery apparatus.

18. An advertisement delivery system for delivering an advertisement to a viewer via a fast communication network, comprising:
advertising content, in a form for transmission on said fast communication network, having one or more advertisements that are focussed on a predetermined target in advance and having an address part that is linked to a WEB site relating to said advertisements;
an advertisement delivery apparatus for delivering said advertising content; and
a receiving device with which the viewer can browse said advertising content, wherein when the viewer performs an operation for browsing said advertising content upon receiving delivery of said advertising content at least one or more times, said advertising content is a connection to said WEB site by the viewer who has made a connection to said WEB site via said advertisement delivery apparatus, and said connected WEB site is a trading site, trading or purchase information from said trading site utilized by the viewer being recorded as a trading history.

19. An advertisement delivery system for delivering an advertisement to a viewer via a fast communication network, comprising:
advertising content, in a form for transmission on said fast communication network, having one or more advertisements that are focussed on a predetermined target in advance and an advertisement delivery apparatus for delivering said advertising content being arranged on said fast communication network; and
new advertising content being generated based on three pieces of information consisting of acquired information, market trend information of a specific market set for each user group which is a target of said advertising content, and trend information of a wider market to which said user group belongs, wherein said acquired information consisting of each of a viewing history that is recorded when the viewer browses said advertising content; a delivery history that is recorded when the viewer receives delivery of said advertising content; a delivery history that is recorded when the viewer receives delivery of said advertising content and performs an operation for browsing said advertising content, and said advertising content makes a connection to a WEB site that is linked to said focussed advertisements via said advertisement delivery apparatus; and a trading history that is recorded as utilization information of a trading site when the viewer performs an operation for browsing said advertising content upon receiving delivery of said advertising content at least one or more times, said advertising content being a connection to said WEB site by the viewer who has made a connection to said WEB site via said advertisement delivery apparatus, and wherein said connected WEB site is said trading site, and wherein
said new advertising content is saved in said advertisement delivery apparatus; and
an indication that said new advertising content is saved in said advertisement delivery apparatus is made available for disclosure to the viewer by predetermined means.

20. An advertisement delivery system for delivering an advertisement to a viewer via a fast communication network, comprising: advertising content, in a form for transmission on said fast communication network, having one or more advertisements that are focussed on a predetermined target in advance and an advertisement delivery apparatus for delivering said advertising content being arranged on said fast communication network; and
new advertising content, in a form for transmission on said fast communication network, is generated based on three pieces of information consisting of acquired information, market trend information of a specific market set for each user group to be a target of said advertising content, and trend information of a wider market to which said user group belongs, wherein said acquired information consists of at least one of a viewing history that is recorded when the viewer browses said advertising content; a delivery history that is recorded when the viewer receives delivery of said advertising content; a delivery history that is recorded when the viewer receives delivery of said advertising content and performs an operation for browsing said advertising content, and said advertising content makes a connection to a WEB site that is linked to said targeted advertisements via said advertisement delivery apparatus; and a trading history that is recorded as utilization information of a trading site when the viewer performs an operation for browsing said advertising content upon receiving delivery of said advertising content at least one or more times, said advertising content being a connection to said WEB site by the viewer who has made a connection to said WEB site via said advertisement delivery apparatus, and said connected WEB site is said trading site, and wherein said new advertising content is saved in said advertisement delivery apparatus; and
an indication that said new advertising content is saved in said advertisement delivery apparatus is made available for disclosure to the viewer by predetermined means.

21. An advertisement delivery system for delivering an advertisement to a viewer via a fast communication network, comprising:
advertising content, in a form for transmission on said fast communication network, having one or more advertisements that are focussed on a predetermined target in advance and an advertisement delivery apparatus for delivering said advertising content being arranged on said fast communication network; and
existing advertising content being updated based on three pieces of information consisting of acquired information, market trend information of a specific market set for each user group to be a target of said advertising content, and trend information of a wider market to which said user group belongs, wherein said acquired information consists of at least one of a viewing history that is recorded when the viewer browses said advertising content; a delivery history that is recorded when the viewer receives delivery of said advertising content; a delivery history that is recorded when the viewer receives delivery of said advertising content and performs an operation for browsing said advertising content, and said advertising content makes a connection to a WEB site that is linked to said targeted advertisements via said advertisement delivery apparatus; and a trading history that is recorded as utilization information of a trading site when the viewer performs an operation for browsing said advertising content upon receiving delivery of said advertising content at least one or more times, said advertising content being a connection to said WEB site by the viewer who has made a connection to said WEB site via said advertisement delivery apparatus, and said connected WEB site is said trading site; and
wherein said updated advertising content is saved in said advertisement delivery apparatus; and
an indication that said updated advertising content is saved in said advertisement delivery apparatus is made available for disclosure to the viewer by predetermined means.

22. An advertisement delivery system for delivering an advertisement to a viewer via a fast communication network, comprising:
advertising content, in a form for transmission on said fast communication network, having one or more advertisements that are focussed on a predetermined target in advance and an advertisement delivery apparatus for delivering said advertising content being arranged on said fast communication network, and
existing advertising content being updated based on three pieces of information consisting of acquired information, market trend information of a specific market set for each user group to be a target of said advertising content, and trend information of a wider market to which said user group belongs, wherein said acquired information consists of: at least one of: a viewing history that is recorded when the viewer browses said advertising content; a delivery history that is recorded when the viewer receives delivery of said advertising content; a delivery history that is recorded when the viewer receives delivery of said advertising content and performs an operation for browsing said advertising content, and said advertising content makes a connection to a WEB site that is linked to said targeted advertisements via said advertisement delivery apparatus; and a trading history that is recorded as utilization information of a trading site when the viewer performs an operation for browsing said advertising content upon receiving delivery of said advertising content at least one or more times, said advertising content is a connection to said WEB site by the viewer who have made a connection to said WEB site via said advertisement delivery apparatus, and said connected WEB site is said trading site; and
wherein said updated advertising content is saved in said advertisement delivery apparatus; and
an indication that said updated advertising content is saved in said advertisement delivery apparatus is made available for disclosure to the viewer by predetermined means.

23. An advertisement delivery system according to claim 19, wherein said advertising content is linked to one or more other advertising content items, the advertising content items are arranged in a multi-layered structure, and an address part that is linked to said WEB site is provided at least in the lowermost advertising content.

24. Advertising content to be delivered to a viewer via a fast communication network, comprising that:
said advertising being in a form for transmission in said fast communication network, said advertising content being programmed, when the viewer receives delivery of said advertising content by a receiving device the viewer uses and performs an operation for browsing said advertising content, to record said browsing operation as a viewing history.

25. Advertising content to be delivered to a viewer via a fast communication network, comprising that:
said advertising being in a form for transmission on said fast communication network, said advertising content is programmed, if the viewer receives delivery of said advertising content by a receiving device the viewer uses and continues an operation for browsing said advertising content for a predetermined length of time or more, to record said browsing operation as a viewing history.

26. Advertising content according to claim 24, wherein the advertising content is programmed such that said viewing history is sent from said receiving device to an advertisement delivery apparatus for delivering said advertising content.

27. Advertising content according to claim 25, wherein the advertising content is programmed such that said viewing history is sent from said receiving device to an advertisement delivery apparatus for delivering said advertising content.

28. Advertising content according to claim 26, comprising that: the advertising content is programmed to record a viewing history, and is programmed such that a viewing history management program for sending said viewing history to an advertisement delivery apparatus for delivering advertising content is incorporated in said receiving device of the viewer upon delivery of advertising content.

29. Advertising content according to claim 27, comprising that: the advertising content is programmed to record a viewing history, and is programmed such that a viewing history management program for sending said viewing history to an advertisement delivery apparatus for delivering advertising content is incorporated in said receiving device of the viewer upon delivery of advertising content.

30. Advertising content to be delivered to a viewer via a fast communication network, comprising:
the advertising content being in a form for transmission on said fast communication network and having an address part that is linked to at least one or more WEB sites; and
said advertising content being programmed, if the viewer receives delivery of advertising content and performs an operation for browsing said advertising content, and the advertising content makes a connection to said WEB sites via an advertisement delivery apparatus for delivering advertising content, to record both a history of delivering advertising content and connection information to said WEB sites thereafter as a delivery history.

31. Advertising content to be delivered to a viewer via a fast communication network, comprising that:
said advertising content is in a form for transmission on said fast communication network and having an address part that is linked to at least one or more WEB sites, and
said advertising content is programmed to record as a trading history utilization information when the viewer performs an operation for browsing the advertising content upon receiving delivery of said advertising content at least one or more times, the advertising content being a connection to said WEB site by the viewer who has made a connection to said WEB site via said advertisement delivery apparatus for delivering advertising content to the viewer, and said connected WEB site is a trading site, utilization information of said trading site utilized by the viewer being recorded as a trading history.

32. Advertising content to be delivered to a viewer via a fast communication network, comprising:
the advertising content in a form for transmission on a fast communication network, arranged in a predetermined layer in a multilayered structure having a link relationship in predetermined advertising content.

33. Advertising content according to claim 32, wherein the advertising content is provided with an address part that is linked to a WEB site relating to the advertising content.

34. Advertising content according to claim 33, wherein the advertising content is arranged in a lowermost layer of said multi-layered structure.

35. An advertisement delivery apparatus for delivering advertising content to a viewer via a fast communication network, comprising:
an advertisement generation element management section for managing various elements for targeting said advertising content to a predetermined target;
an advertisement data management section for managing advertisement data forming said advertising content;
an acquired information management section for managing at least one or more history information among acquired information consisting of each of: a viewing history that is recorded when the viewer browses said advertising content; a delivery history that is recorded when the viewer receives delivery of said advertising content; a delivery history that is recorded when the viewer receives delivery of said advertising content and said advertising content performs an operation for browsing said advertising content, and makes a connection to a WEB site relating to said advertising content via said advertisement delivery apparatus; and a trading history that is recorded as utilization information when the viewer performs an operation for browsing said advertising content upon receiving delivery of said advertising content at least one or more times, said advertising content is a connection to said WEB site by the viewer who has made a connection to said WEB site via said advertisement delivery apparatus, and said connected WEB site is said trading site, and when the viewer utilized said trading site;
an advertising content generation section for creating said advertising content having one or more advertisements that are focussed on a predetermined target by selecting advertisement data from said advertisement data management section considering various elements managed by said advertisement generation element management section and history information managed by said acquired information management section; and
an advertising content delivery section that is capable of delivering advertising content generated in said advertising content generation section to a viewer via said fast communication network.

36. An advertisement delivery apparatus according to claim 35, wherein said various elements for targeting advertising content to said predetermined target include market trend information of a specific market set for each user group which is said predetermined target, trend information of a wider market to which said user group belongs, and an intention of an advertiser, source of an advertisement included in said advertising content, and is provided with first analyzing means for analyzing said market trend information and second analyzing means for analyzing said wider market trend information.

37. An advertisement delivery apparatus, comprising:
an advertisement generation element management section for managing various elements for targeting said advertising content to a predetermined target;
an advertisement data management section for managing advertisement data forming said advertising content;
an acquired information management section for managing at least one or more history information among acquired information consisting of each of: a viewing history that is recorded when the viewer browses said advertising content; a delivery history that is recorded when the viewer receives delivery of said advertising content; a delivery history that is recorded when the viewer receives delivery of said advertising content and said advertising content performs an operation for browsing said advertising content, and makes a connection to a WEB site relating to said advertising content via said advertisement delivery apparatus; and a trading history that is recorded as utilization information when the viewer performs an operation for browsing said advertising content upon receiving delivery of said advertising content at least one or more times, said advertising content is a connection to said WEB site by the viewer who have made a connection to said WEB site via said advertisement delivery apparatus, and said connected WEB site is said trading site, and when the viewer utilized said trading site; and
advertising content generation section for creating said advertising content having one or more advertisements that are focussed on a predetermined target by selecting advertisement data from said advertisement data management section considering various elements managed by said advertisement generation element management section and history information managed by said acquired information management section.

38. An advertisement delivery apparatus comprising an advertisement delivery section that is capable of delivering advertising content in a form for transmission on a fast communication network having one or more advertisements that are focussed on a predetermined target to a viewer via the fast communication network.

39. An advertisement delivery apparatus, delivering advertising content having one or more advertisements that are focussed on a predetermined target to a viewer via a fast communication network, and comprising:
an acquired information management section for managing at least one or more history information among acquired information consisting of each of: a viewing history that is recorded when the viewer browses said advertising content; a delivery history that is recorded when the viewer receives delivery of said advertising content; a delivery history that is recorded when the viewer receives delivery of said advertising content and said advertising content performs an operation for browsing said advertising content, and makes a connection to a WEB site relating to said advertising content via said advertisement delivery apparatus; and a trading history that is recorded as utilization information when the viewer performs an operation for browsing said advertising content upon receiving delivery of said advertising content at least one or more times, said advertising content is a connection to said WEB site by the viewer who have made a connection to said WEB site via said advertisement delivery apparatus, and said connected WEB site is said trading site, and when the viewer utilized said trading site.

40. An advertisement delivery apparatus for delivering advertising content to a viewer via a fast communication network, comprising:
an advertisement generation element management section for managing various elements for targeting said advertising content to a predetermined target;
an advertisement data management section for managing advertisement data forming said advertising content;
an acquired information management section for managing at least one or more history information among acquired information consisting of each of: a viewing history that is recorded when the viewer browses said advertising content; a delivery history that is recorded when the viewer receives delivery of said advertising content; a delivery history that is recorded when the viewer receives delivery of said advertising content and said advertising content performs an operation for browsing said advertising content, and makes a connection to a WEB site relating to said advertising content via said advertisement delivery apparatus; and a trading history that is recorded as utilization information when the viewer performs an operation for browsing said advertising content upon receiving delivery of said advertising content at least one or more times, said advertising content is a connection to said WEB site by the viewer who have made a connection to said WEB site via said advertisement delivery apparatus, and said connected WEB site is said trading site, and when the viewer utilized said trading site;
an advertising content generation section for creating said advertising content having one or more advertisements that are focussed on a predetermined target by selecting advertisement data from said advertisement data management section considering various elements managed by said advertisement generation element management section and history information managed by said acquired information management section; and
an advertising content delivery section that is capable of delivering said advertising content to a viewer via said fast communication network, wherein said advertising content generation section updates said advertising content in said advertising content delivery section by replacing said advertising content generated by said advertising content generation section with an arbitrary one among existing advertising content originally provided in said advertising content delivery section that have the same target or do not have the same target.

41. An advertisement delivery apparatus for delivering advertising content to a viewer via a fast communication network, comprising:
an advertising content generation section for creating advertising content having one or more advertisements that is focussed on a predetermined target;
an advertisement data management section for managing advertisement data forming said advertising content;
an advertising content delivery section that is capable of delivering said advertising content to said viewer via said fast communication network; and
a retrieving section for retrieving and extracting advertisement data from at least one of said advertisement data management section and another advertisement delivery apparatus connected to said advertisement delivery apparatus via or not via said fast communication network;
when the viewer sends a retrieval request to said advertisement delivery apparatus, said advertising content generation section creates new advertising content based on said advertisement data retrieved and extracted by said retrieving section according to said retrieval request, and said generated advertising content is delivered to the viewer from said advertising content delivery section.

42. An advertisement delivery apparatus for delivering advertising content to a viewer via a fast communication network, comprising:
advertising content generation section for creating advertising content having one or more advertisements that is focussed on a predetermined target;
an advertisement data management section for managing advertisement data forming said advertising content;
an advertising content delivery section that is capable of delivering said advertising content to said viewer via said fast communication network; and
a retrieving section for retrieving and extracting advertisement data from at least one of said advertisement data management sections and another advertisement delivery apparatus connected to said advertisement delivery apparatus via or not via said fast communication network;
wherein said retrieving section starts retrieval and extraction of advertisement data according to a retrieval starting instruction, and said advertising content generation section creates new advertising content based on said extracted advertisement data.

43. An advertisement delivery apparatus comprising a retrieving section for retrieving and extracting advertisement data from another advertisement delivery apparatus connected to an advertisement delivery apparatus via or not via a fast communication network.

44. An advertisement delivery apparatus for delivering advertising content to a viewer via a fast communication network, comprising:
an advertisement generation element management section for managing various elements for targeting said advertising content to a predetermined target;
an advertisement data management section for managing advertisement data forming said advertising content;
an acquired information management section for managing at least one or more history information among acquired information consisting of each of: a viewing history that is recorded when the viewer browses said advertising content; a delivery history that is recorded when the viewer receives delivery of said advertising content; a delivery history that is recorded when the viewer receives delivery of said advertising content and said advertising content performs an operation for browsing said advertising content, and makes a connection to a WEB site relating to said advertising content via said advertisement delivery apparatus; and a trading history that is recorded as utilization information when the viewer performs an operation for browsing said advertising content upon receiving delivery of said advertising content at least one or more times, said advertising content is a connection to said WEB site by the viewer who have made a connection to said WEB site via said advertisement delivery apparatus, and said connected WEB site is said trading site, and when the viewer utilized said trading site;
an advertising content generation section for creating said advertising content having one or more advertisements that are focussed on a predetermined target by selecting advertisement data from said advertisement data management section considering various elements managed by said advertisement generation element management section and history information managed by said acquired information management section;
an advertising content delivery section that is capable of delivering said advertising content generated by said advertising content generation section to a viewer via said fast communication network; and
a retrieving section for retrieving and extracting advertisement data from at least one of said advertisement data management section and another advertisement delivery apparatus connected to said advertisement delivery apparatus via or not via said fast communication network.

45. An advertisement delivery method for delivering an advertisement to a viewer via a fast communication network, comprising:
arranging advertising content in a form for transmission on said fast communication network having one or more advertisements that are focussed on a predetermined target in advance and having an address part that is linked to a WEB site relating to said advertisements is arranged on said fast communication network; and
delivering said advertising content to the viewer based on requests of the viewer.

46. An advertisement delivery method for delivering an advertisement to a viewer via a fast communication network, comprising:
arranging advertising content in a form for transmission on said fast communication network having one or more advertisements that are focussed on a predetermined target in advance and having an address part that is linked to another advertising content relating to said advertisements is arranged on said fast communication network; and
delivering said advertising content to the viewer based on a request of the viewer.

47. An advertisement delivery method for delivering an advertisement to a viewer via a fast communication network, comprising:
delivering advertising content in a form for transmission on said fast communication network having one or more advertising components in which management information is added to advertisement data and an advertisement is focussed on a predetermined target by at least one of: a predetermined genre, a predetermined category and a predetermined concept and being configured with an arbitrary time being delivered to the viewer.

48. An advertisement delivery method for delivering an advertisement to a viewer via a fast communication network, comprising:
automatically generating new advertising content based on at least one of: multiple viewing histories, delivery histories and trading histories of the viewer;
arranging said new advertising content on said fast communication network; and
delivering said new advertising content to the viewer based on a delivery request of the viewer.

49. An advertisement delivery method for delivering an advertisement to a viewer via a fast communication network, comprising:
recording a delivery history when advertising content having one or more advertisements that are focussed on a predetermined target in advance, and having an address part that is linked to a WEB site relating to said advertisements is delivered to the viewer based on a delivery request of the viewer;
recording a viewing history when the viewer browses said advertising content;
recording a delivery history when the viewer browses said advertising content; and, in addition, said advertising content makes a connection to said WEB site via said advertisement delivery apparatus that delivers said advertising content; and
recording a trading history as utilization information when the viewer performs an operation for browsing said advertising content upon receiving delivery of said advertising content at least one or more times, said advertising content being a connection to said WEB site by the viewer who has made a connection to said WEB site via said advertisement delivery apparatus, and said connected WEB site being trading site, and when the viewer utilized said trading site; and
utilizing at least one or more of said histories in creating said advertising content.
